(19) United States
(12) Patent Application Publication
(10) Pub. No.: US 2024/0389047 A1
(43) Pub. Date: Nov. 21, 2024

(54) METHOD AND APPARATUS FOR REGISTERING SERVICE-BASED USER PLANE, COMMUNICATION DEVICE AND SYSTEM, AND STORAGE MEDIUM

(71) Applicant: VIVO MOBILE COMMUNICATION CO., LTD., Dongguan (CN)

(72) Inventors: Huazhang LV, Dongguan (CN); Weiwei CHONG, Dongguan (CN)

(73) Assignee: VIVO MOBILE COMMUNICATION CO., LTD., Dongguan (CN)

(21) Appl. No.: 18/786,566

(22) Filed: Jul. 28, 2024

Related U.S. Application Data
(63) Continuation of application No. PCT/CN2023/073177, filed on Jan. 19, 2023.

(30) Foreign Application Priority Data
Jan. 28, 2022 (CN) 202210108393.2

(51) Int. Cl. H04W 60/00; H04W 8/20

(52) U.S. Cl. CPC H04W 60/00; H04W 8/20

(57) ABSTRACT

A method and an apparatus for registering a service-based user plane, a method and an apparatus for determining a user plane, a method and an apparatus for subscribing to user plane service information, a communication device and system, and a storage medium, are provided. The method for registering a service-based user plane includes: sending, by a first network element, a target request to a second network element, where the target request is a registration request or a registration update request, and the target request is used to request to register the first network element to the second network element; and in a case that the first network element registers with the second network element, another network element is configured to discover the first network element through the second network element.

### CROSS-REFERENCE TO RELATED APPLICATIONS

This application is a continuation of International Application No. PCT/CN2023/073177, filed on Jan. 19, 2023, which claims priority to Chinese Patent Application No. 202210108393.2, filed Jan. 28, 2022. The entire contents of each of the above-identified applications are expressly incorporated herein by reference.

### TECHNICAL FIELD

This application pertains to the field of communication technologies, and specifically relates to a method and an apparatus for registering a service-based user plane, a method and an apparatus for determining a user plane, a method and an apparatus for subscribing to user plane service information, a communication device and system, and a storage medium.

### BACKGROUND

With continuous development of communication technologies, most network elements and interfaces in a 5th Generation (5G) core network have been service-based. However, currently, a User Plane Function (UPF) network element in the 5G core network is not service-based Another network element cannot invoke a service of the UPF network element, and the UPF network element can only be controlled by a Session Management Function (SMF) network element but cannot use a service of another 5G network element. However, currently, a specific solution is not provided for designing a service-based UPF network element. Therefore, how to design a service-based UPF network element is an urgent problem to be resolved.

### SUMMARY

Embodiments of this application provide a method and an apparatus for registering a service-based user plane, a method and an apparatus for determining a user plane, a method and an apparatus for subscribing to user plane service information, a communication device and system, and a storage medium.

According to a first aspect, a method for registering a service-based user plane is provided. The method includes: sending, by a first network element, a target request to a second network element, where the target request is a registration request or a registration update request, and the target request is used to request to register the first network element to the second network element; and in a case that the first network element registers with the second network element, another network element can discover the first network element through the second network element.

According to a second aspect, an apparatus for registering a service-based user plane is provided. The apparatus for registering a service-based user plane includes a sending module. The sending module is configured to send a target request to a second network element, where the target request is a registration request or a registration update request, and the target request is used to request to register a first network element to the second network element; and in a case that the first network element registers with the second network element, another network element can discover the first network element through the second network element.

According to a third aspect, a method for determining a user plane is provided. The method includes: sending, by a third network element, a query request to a second network element, where the query request is used to request the second network element to search for a first network element, the query request includes second target indication information, and the second target indication information is used to indicate the first network element that meets a target condition.

According to a fourth aspect, an apparatus for determining a user plane is provided. The apparatus for determining a user plane includes a sending module. The sending module is configured to send a query request to a second network element, where the query request is used to request the second network element to search for a first network element, the query request includes second target indication information, and the second target indication information is used to indicate the first network element that meets a target condition.

According to a fifth aspect, a method for subscribing to user plane service information is provided. The method includes: sending, by a fourth network element, a subscription request to a first network element, where the subscription request is used to request to subscribe to a related service of the first network element, and the subscription request includes related information of the first network element; and receiving, by the fourth network element, notification information sent by the first network element, where the notification information includes the related service of the first network element.

According to a sixth aspect, an apparatus for subscribing to user plane service information is provided. The apparatus for subscribing to user plane service information includes a sending module and a receiving module. The sending module is configured to send a subscription request to a first network element, where the subscription request is used to request to subscribe to a related service of the first network element, and the subscription request includes related information of the first network element. The receiving module is configured to receive notification information sent by the first network element, where the notification information includes the related service of the first network element.

According to a seventh aspect, a network element is provided. The network element includes a processor and a memory, the memory stores a program or an instruction that can be run on the processor, and the program or the instruction is executed by the processor to implement the steps of the method for registering a service-based user plane according to the first aspect.

According to an eighth aspect, a network element is provided, including a processor and a communication interface. The communication interface is configured to send a target request to a second network element, where the target request is a registration request or a registration update request, and the target request is used to request to register a first network element to the second network element; and in a case that the first network element registers with the second network element, another network element can discover the first network element through the second network element.

According to a ninth aspect, a network element is provided. The network element includes a processor and a memory, the memory stores a program or an instruction that can be run on the processor, and the program or the instruction is executed by the processor to implement the steps of the method for determining a user plane according to the third aspect.

According to a tenth aspect, a network element is provided, including a processor and a communication interface. The communication interface is configured to send a query request to a second network element, where the query request is used to request the second network element to search for a first network element, the query request includes second target indication information, and the second target indication information is used to indicate the first network element that meets a target condition.

According to an eleventh aspect, a network element is provided. The network element includes a processor and a memory, the memory stores a program or an instruction that can be run on the processor, and the program or the instruction is executed by the processor to implement the steps of the method for subscribing to user plane service information according to the fifth aspect.

According to a twelfth aspect, a network element is provided, including a processor and a communication interface. The communication interface is configured to: send a subscription request to a first network element, where the subscription request is used to request to subscribe to a related service of the first network element, and the subscription request includes related information of the first network element; and receive notification information sent by the first network element, where the notification information includes the related service of the first network element.

According to a thirteenth aspect, a communication system is provided, including the apparatus for registering a service-based user plane according to the second aspect, the apparatus for determining a user plane according to the fourth aspect, and the apparatus for subscribing to user plane service information according to the sixth aspect; or including the network elements according to the seventh aspect, the ninth aspect, and the eleventh aspect; or including the network elements according to the eighth aspect, the tenth aspect, and the twelfth aspect, where the network elements may be configured to perform the steps of the methods according to the first aspect, the third aspect, and the fifth aspect.

According to a fourteenth aspect, a readable storage medium is provided. The readable storage medium stores a program or an instruction, and the program or the instruction is executed by a processor to implement the steps of the method according to the first aspect, the steps of the method according to the third aspect, or the steps of the method according to the fifth aspect.

According to a fifteenth aspect, a chip is provided. The chip includes a processor and a communication interface, the communication interface is coupled to the processor, and the processor is configured to run a program or an instruction to implement the method according to the first aspect, the method according to the third aspect, or the method according to the fifth aspect.

According to a sixteenth aspect, a computer program/program product is provided. The computer program/program product is stored in a storage medium, and the computer program/program product is executed by at least one processor to implement the steps of the method for registering a service-based user plane according to the first aspect, the steps of the method for determining a user plane according to the third aspect, or the steps of the method for subscribing to user plane service information according to the fifth aspect.

In the embodiments of this application, the first network element may register the first network element to the second network element through a registration response or a registration update response.

The third network element may request, through the query request, the second network element to search for the first network element. Because the query request includes the second target indication information indicating the first network element that meets the target condition, the second network element can discover the first network element that meets the target condition (that is, meets a requirement of the third network element).

In a case that a third network element discovers the first network element, the fourth network element may directly or indirectly send the subscription request to the first network element to subscribe to the related service of the first network element, that is, may directly subscribe to the related service of the first network element, or indirectly subscribe to the related service of the first network element through the third network element.

### BRIEF DESCRIPTION OF DRAWINGS

FIG. 1 is a block diagram of a wireless communication system according to an embodiment of this application;

FIG. 2 is a block diagram of a device in a 5G network according to an embodiment of this application;

FIG. 3 is a first flowchart of a method for registering a service-based user plane according to an embodiment of this application;

FIG. 4 is a second flowchart of a method for registering a service-based user plane according to an embodiment of this application;

FIG. 5 is a first flowchart of a method for determining a user plane according to an embodiment of this application;

FIG. 6 is a second flowchart of a method for determining a user plane according to an embodiment of this application;

FIG. 7 is a first flowchart of a method for subscribing to user plane service information according to an embodiment of this application;

FIG. 8 is a second flowchart of a method for subscribing to user plane service information according to an embodiment of this application;

FIG. 9 is a third flowchart of a method for subscribing to user plane service information according to an embodiment of this application;

FIG. 10 is a fourth flowchart of a method for subscribing to user plane service information according to an embodiment of this application;

FIG. 11 is a fifth flowchart of a method for subscribing to user plane service information according to an embodiment of this application;

FIG. 12 is a third flowchart of a method for registering a service-based user plane according to an embodiment of this application;

FIG. 13 is a third flowchart of a method for determining a user plane according to an embodiment of this application;

FIG. 14 is a sixth flowchart of a method for subscribing to user plane service information according to an embodiment of this application;

FIG. 15 is a seventh flowchart of a method for subscribing to user plane service information according to an embodiment of this application;

FIG. 16 is an eighth flowchart of a method for subscribing to user plane service information according to an embodiment of this application;

FIG. 17 is a ninth flowchart of a method for subscribing to user plane service information according to an embodiment of this application;

FIG. 18 is a block diagram of an apparatus for registering a service-based user plane according to an embodiment of this application;

FIG. 19 is a block diagram of an apparatus for determining a user plane according to an embodiment of this application;

FIG. 20 is a block diagram of an apparatus for subscribing to user plane service information according to an embodiment of this application;

FIG. 21 is a block diagram of hardware of a communication device according to an embodiment of this application; and

FIG. 22 is a block diagram of hardware of a network element according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first,” “second,” and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

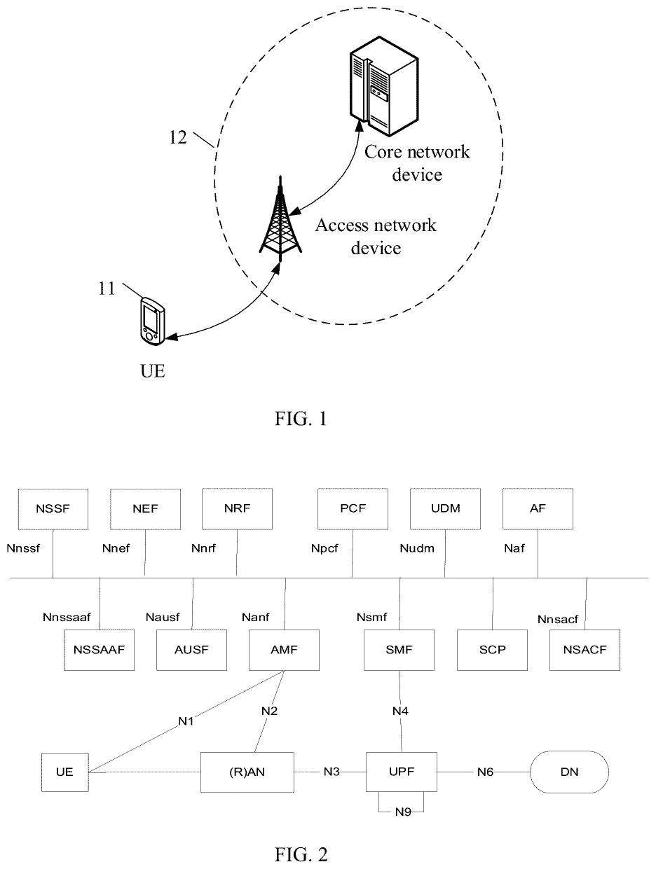

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a personal computer, a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a user plane function, a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

The following describes some concepts and/or terms in a method and an apparatus for registering a service-based user plane, a method and an apparatus for determining a user plane, a method and an apparatus for subscribing to user plane service information, a communication device and system, and a storage medium provided in the embodiments of this application.

Currently, in a 5G core network, user plane UPF network elements (including a PDU session anchor (PSA) network element and an Uplink Classifier (UL CL) network element, all of which are referred to as UPF network elements) are not service-based. Service-based is a new architecture introduced by a 5G core network architecture. In a Service Based Architecture (SBA), interaction between network functions is implemented by service call. Each network function serves as a common service-based interface externally, and may be authorized for a network function or service call.

However, network architectures of a traditional 2th Generation (2th Generation, 2G) core network, a 3th Generation (3th Generation, 3G) core network, and a 4th Generation (4th Generation, 4G) core network are “peer-to-peer” architectures. An interface between network elements needs to be predefined and configured, and the defined interface can only be used between specific two types of network elements, which is not flexible. In a current 3rd Generation Partnership Project (3GPP) protocol, SBA interface protocols are combined: a Transmission Control Protocol (TCP), a Hypertext Transport Protocol (HTTP), a HTTP/2, a lightweight data interchange format based on a JavaScript language (JavaScript Object Notation, JSON), Restful, and OpenAPI 3.0. This protocol design brings many advantages: facilitating adoption of new Internet technologies, implementing rapid deployment, continuous integration and release of new network services, and facilitating operator-owned or third-party service development.

At present, most network elements and interfaces in the 5G core network are service-based, but a user plane UPF is not service-based. Other network elements cannot invoke a service of the UPF network element, and the UPF network element can only be controlled by an SMF network element but cannot use services of the other 5GC network elements.

As shown in FIG. 2, a 5G network includes User Equipment (UE), a RAN device, and a 5G core network device. The 5G core network device includes a Network Slice Selection Function (NSSF) network element, an NEF network element, an NRF network element, a PCF network element, a UDM network element, an AF network element, an NSSAAF network element, an Authentication Server Function (AUSF) network element, an AMF network element, an SMF network element, a Service Communication Proxy (SCP) network element, an NSACF network element, a UPF network element, and a Data Network (DN).

An interface between the UE and the AMF network element is an N1 interface, an interface between the RAN and the AMF network element is an N2 interface, an interface between the RAN and the UPF network element is an N3 interface, an interface between the UPF network element and the SMF network element is a customized N4 interface, and an interface between the UPF and the DN network element is an N6 interface. An interface of the NSSAAF network element is an Nnssaaf interface, an interface of the AUSF network element is an Nausf interface, an interface of the AMF network element is an Namf interface, an interface of the SMF network element is an Nsmf interface, an interface of the NSACF network element is an Nnsacf interface, an interface of the NSSF network elements is an Nnssf interface, an interface of the NEF network element is an Nnef interface, an interface of the NRF network element is an Npcf interface, an interface of the PCF network element is an Npcf interface, an interface of the UDM network element is an Nudm interface, an interface of the AF network element is an Naf interface, and an interface of the UPF network element is an N9 interface. In the foregoing interfaces, interfaces such as N4 are all belong to customized peer-to-peer interface, and interfaces such as Namf are service-based interfaces.

At present, this non-service-based user plane UPF network element has many disadvantages. For example, the UPF is a network element that performs data transmission and forwarding. Herein, many Quality of Service (QOS)-related measurement information can be detected, for example, a sending rate of an uplink or downlink packet of a user, a bandwidth, and a quantity of lost uplink or downlink packets. If the QoS-related information is to be obtained, the UPF network element only can report the information to an SMF network element, and then the SMF network element expose the information to another network element. This information exposure mode is not convenient enough, because the information cannot be directly exposed by the data source and needs to be sent through the SMF network element. For example, if an AF network element wants to subscribe to QoS monitoring information, the UPF network element needs to report the QoS monitoring to the SMF network element, the SMF network element reports the QoS monitoring to a PCF network element, and then the PCF network element sends the QoS monitoring to the AF network element through an NEF network element. This manner is complex and time-consuming. All user plane data collected or output by the UPF needs to be bypassed from a control plane and then is sent to a peer device. In addition, because the UPF network element is not service-based, all data plane information such as QoS needs to be collected from the user plane UPF network element to the control plane SMF network element before being sent. In fact, this way seriously affects timeliness, and is not convenient and flexible.

With reference to the accompanying drawings, the following describes in detail a method for registering a service-based user plane, a method for determining a user plane, and a method for subscribing to user plane service information provided in the embodiments of this application by using some embodiments and application scenarios thereof.

At present, for the UPF network element, other network elements cannot invoke a service of the UPF network element, and the UPF network element can only be controlled by the SMF network element but cannot use services of the other 5G network elements. (1). If the UPF is a service-based network element, how to register with an NRF network element and be discovered by an SMF network element is a problem to be resolved. (2) For another network element (for example, an AF network element or a Network Data Analytics Function (NWDAF) network element), how to obtain, from the UPF network element, a related service exposed by the UPF network element is a problem to be resolved.

In the embodiments of this application, a service-based user plane is designed. The user plane can provide a service-based interface, and provide a related service of the user plane for another 5GC network element for direct invoking, or another network element invokes a related service of the user plane through an SMF network element. In addition, the service-based network element may also use a service of another network element, for example, a UPF network element uses a related service exposed by the SMF network element.

Specifically, in a solution, a UPF network element may register with an NRF network element through a registration request or a registration update request, to enable/support another network element to discover the UPF network element through the NRF network element, thereby directly or indirectly invoking a related service exposed by the UPF network element.

In another solution, an SMF network element may request, through a query request, an NRF network element to search for a UPF network element to discover a network element that meets a requirement (a network element that meets a target condition).

In still another solution, in a case that an SMF network element discovers a UPF network element, an AF network element or an NWDAF network element may directly or indirectly send a subscription request to the UPF network element to subscribe to a related service of the UPF network element, that is, directly subscribe to the related service of the UPF network element, or indirectly subscribe to the related service of the UPF network element through the SMF network element.

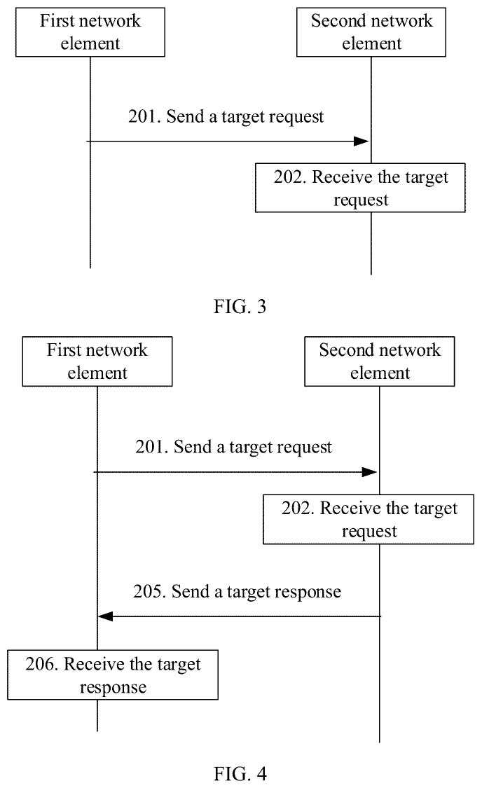

An embodiment of this application provides a method for registering a service-based user plane. FIG. 3 is a flowchart of a method for registering a service-based user plane according to an embodiment of this application. As shown in FIG. 3, the method for registering a service-based user plane provided in this embodiment of this application may include the following step 201 and step 202.

Step 201: A first network element sends a target request to a second network element.

In this embodiment of this application, the target request is a registration request or a registration update request, and the target request is used to request to register the first network element to the second network element. In a case that the first network element registers with the second network element, another network element can discover the first network element through the second network element.

Step 202: The second network element receives the target request sent by the first network element.

In some implementations, the first network element may be a UPF network element, a PSA network element, a UL CL network element, and the second network element may be an NRF network element. The NRF network element is a network element used to search for a network element inside 5G.

In some implementations, the UPF network element may send an Nnrf_NFManagement_NFRegister registration request to the NRF network element, to request to register the UPF network element to the NRF network element.

In some implementations, the target request includes at least one of the following: related information of the first network element and first target indication information. The first target indication information is used to indicate whether the first network element is a service-based user plane network element.

In some implementations, the related information of the first network element includes at least one of the following: an Internet Protocol IP address of UE, a Subscription Permanent Identifier (SUPI) or a Generic Public Subscription Identifier (GPSI) of the UE, a Data Network Name (DNN) of the UE, Single Network Slice Selection Assistance Information (S-NSSAI) of the UE, a related service supported by the first network element, a related service that is of the first network element and that is requested for subscription, and fourth indication information, where the fourth indication information is used to instruct the first network element that requests service orientation to provide the related service of the first network element.

In some implementations, the related service supported by the first network element is used during registration, that is, which service is supported by the first network element, and the related service that is requested for subscription is used during subscription of the fourth network element, that is, which service the fourth network element wants to obtain. In some implementations, the first target indication information includes at least one of the following: first indication information, second indication information, and third indication information, where the first indication information is used to indicate whether the first network element can expose the related service of the first network element to another network element, the second indication information is used to indicate whether the related service of the first network element is allowed to be directly or indirectly subscribed by another network element, and the third indication information is used to indicate whether the first network element has a capability of obtaining a related service of another network element.

In some implementations, the another network element may be an AMF network element, an SMF network element, an NEF network element, an AF network element, an NWDAF network element, or the like.

In some implementations, if the related service of the first network element is directly subscribed, a subscriber directly triggers Nupf_EventExposure_Subscribe to a UPF. If the related service of the first network element cannot be directly subscribed, an event of a UPF network element needs to be subscribed through an SMF network element.

In some implementations, the indicating whether the first network element has a capability of obtaining a related service of another network element may be obtaining a related service provided by an SMF network element, a PCF network element, or an NWDAF network element.

In some implementations, the related service of the first network element includes at least one of the following: a quality of service QoS flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, and QoS monitoring indication information of the first network element. The first device is the first network element or UE, and the QoS monitoring indication information is used to indicate whether the first network element can provide QoS monitoring through service-based signaling.

For example, in a case that the UPF network element registers with the NRF network element, an indication is added to the Nnrf_NFManagement_NFRegister registration request. The indication is used to describe that the UPF network element can expose a QoS monitoring report to the NEF network element, the AF network element, or the NWDAF network element through Nupf_EventExposure_Notify.

In some implementations, the quality of service QoS flow bit rate of the first device is a QoS flow bit rate (per UE or per UPF): observably, an uplink or downlink bit rate of UE; or all uplink or downlink bit rates carried by this UPF.

In some implementations, the QoS flow packet delay of the first device is a QoS flow packet delay (per UE or per UPF): observably, an uplink or downlink packet delay of UE; or all uplink or downlink packet delays carried by this UPF.

In some implementations, the quantity of packets transmitted by the first device is packet transmission (per UE or per UPF): observably, a quantity of packets transmitted by UE (in an uplink or a downlink); or data of a packet transmitted by this UPF (in an uplink or a downlink).

In some implementations, the quantity of packets retransmitted by the first device is packet retransmission (per UE or per UPF): observably, a quantity of packets retransmitted by UE (in an uplink or a downlink); or data of a packet retransmitted by this UPF (in an uplink or a downlink).

In some implementations, the resource information of the first network element is a UPF resource: a resource status of the UPF, including a current available or total CPU load or computing power, a storage space, and a disk capacity of the UPF.

In some implementations, the load information of the first network element is a UPF load: a load status of the UPF in a time interval, for example, a quantity of PDU sessions currently carried by the UPF, and a quantity of forwarded packets (a forwarding capability).

In some implementations, the traffic volume of the first network element is a UPF traffic volume: a traffic volume of the UPF, that is, a traffic status of the UPF for a session or a UE in a communication process within a time period, which may be a peak value of traffic, or may be an average value of traffic.

In some implementations, the throughput of the first network element is a UPF throughput: an uplink or downlink throughput, or a throughput, a peak value, or an average value within a time interval.

In some implementations, the QoS monitoring indication information of the first network element is QoS monitoring: whether the UPF can provide QoS monitoring. For example, QoS monitoring includes uplink, downlink, and loopback delay measurement. A QoS flow packet delay may also be measured.

In some implementations, the first network element provides the related service of the first network element through service-based signaling, and the service-based signaling includes at least one of the following: Nupf_EventExposure_Notify.

In some implementations, each service in the related service of the first network element corresponds to one event identifier (Event ID). After the foregoing step 202, the method for registering a service-based user plane provided in this embodiment of this application further includes the following step 203 and step 204.

Step 203: The first network element receives a subscription request sent by another network element.

In this embodiment of this application, the subscription request is used to request to subscribe to the related service of the first network element, and the subscription request includes at least one event identifier.

For example, an AF network element, an NWDAF network element, or an SMF network element may trigger Nupf_EventExposure_Subscribe to a UPF network element, and request to subscribe to a related service of the UPF network element.

Step 204: The first network element sends a service corresponding to the at least one event identifier in the related service of the first network element to the another network element through service-based signaling.

In some implementations, the first network element may indicate that the first network element may use a service of the SMF network element, and then the first network element may indicate a service type of the SMF network element that the first network element can use or hopes to obtain, and use an event identifier ID, for example, obtain the related service of the SMF network element from the SMF network element.

In some implementations, the first network element provides the related service of the first network element through service-based signaling, and the service-based signaling includes at least one of the following notification information: Nupf_EventExposure_Notify.

In some implementations, the first target indication information includes the third indication information. For example, the first network element has a capability of obtaining a related service of a session management function SMF network element, and the related service of the SMF network element is a service that the SMF network element can expose. That is, a UPF network element may subscribe to a related service of the SMF network element through Nsmf_EventExposure_Subscribe, and the SMF network element may also send, to the service-based UPF network element through Nsmf_EventExposure_Notify, the service that is of the SMF network element and that is subscribed by the UPF network element.

In some implementations, the SMF network element sends the related service of the SMF network element to the related service of the first network element through a notification such as Nsmf_EventExposure_Notify.

In some implementations, the related service of the SMF network element includes at least one of the following:
UE Internet Protocol IP address/prefix provision, or UE IP address/prefix change notification (UE IP address/Prefix allocation/change);
protocol data unit PDU session establishment and/or PDU session release notification (PDU Session Establishment and/or PDU Session Release);
a user plane UP path change notification service (UP path change);
a change notification service of an access type (Change of Access Type);
a change notification service of a radio access technology RAT type (Change of RAT Type);
a public land mobile network PLMN change notification service (PLMN change);
a quality of service flow identifier QFI configuration service (QFI allocation); PDU session information of a wireless local area network (Information on PDU Session for WLAN);
user plane status information (User plane status information);
a session management congestion control capability of a PDU session (Session Management Congestion Control Experience for PDU Session);
a UE session behavior trend (UE session behavior trends);
UE behavior (UE behavior); and
a UE communications trend (UE communications trends).

In some implementations, the first target indication information includes the third indication information. For example, the first network element has a capability of obtaining a related service of a network data analytics function NWDAF network element, and the related service of the NWDAF network element is an analytics function, a data collection function, or a statistical function that the NWDAF network element can expose.

In some implementations, the first network element may indicate that the first network element may use a service of the NWDAF network element, or indicate a service of the NWDAF network element that the first network element wishes to obtain or use. Then, the first network element may indicate a service type of the NWDAF network element that the first network element hopes to obtain or use, and use an analytics (Analytics) identifier ID, for example, obtain the related service of the NWDAF network element from the NWDAF network element.

In some implementations, the related service of the NWDAF network element includes at least one of the following:
load level information (Analytics ID: load level information);
service experience information (Analytics ID: Service Experience);
network element load information (Analytics ID: NF load information);
network performance statistics or prediction (Analytics ID: Network Performance);
UE mobility statistics or prediction (Analytics ID: UE Communication);
UE communication analytics or prediction (Analytics ID: UE Mobility and/or UE Communication);
terminal abnormal behavior analytics or prediction (Analytics ID: Abnormal behavior);
user data congestion analytics or prediction (Analytics ID: User Data Congestion);
QoS sustainability analytics or prediction (Analytics ID: QOS Sustainability);
session management congestion control experience analytics or prediction (Analytics ID: Session Management Congestion Control Experience);
redundant transmission experience analytics or prediction (Analytics ID: Redundant Transmission Experience);
wireless local area network performance analytics or prediction (Analytics ID: WLAN performance);
UE dispersion (Analytics ID: UE Dispersion);
data network performance analytics or prediction (Analytics ID: DN Performance); and
a capability of the related service of the NWDAF network element.

In some implementations, an analytics identifier Analytics ID is used. The first network element requests a corresponding service by adding the analytics identifier to the subscription request.

For example, network element may trigger a UPF a service Nnwdaf_AnalyticsSubscription_Subscribe or Nnwdaf_AnalyticsInfo_Request of an NWDAF network element, to request to subscribe to the service from the NWDAF network element or obtain the service provided by the NWDAF network element. In each piece of signaling, an event ID is added, and identification is performed through the event ID.

In some implementations, with reference to FIG. 3, as shown in FIG. 4, after the foregoing step 202, the method for registering a service-based user plane provided in this embodiment of this application further includes the following step 205 and step 206.

Step 205: The second network element sends a target response to the first network element.

In this embodiment of this application, the target response is a registration response or a registration update response, and the target response is used to instruct the first network element to complete registration or registration update.

Step 206: The first network element receives the target response sent by the second network element.

This embodiment of this application further provides the method for registering a service-based user plane. The first network element may register the first network element to the second network element through a registration response or a registration update response, so that another network element can discover the first network element through the second network element, thereby resolving a problem of how a UPF network element registers with an NRF network element and can be discovered by an SMF network element.

It should be noted that, the method for registering a service-based user plane provided in this embodiment of this application may be performed by an apparatus for registering a service-based user plane, or a control module that is in the apparatus for registering a service-based user plane and that is configured to perform the method for registering a service-based user plane.

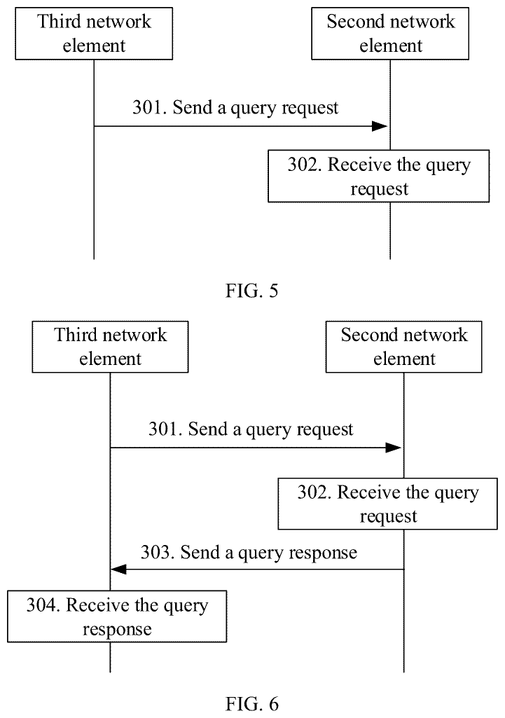

An embodiment of this application further provides a method for determining a user plane. FIG. 5 is a flowchart of a method for determining a user plane according to an embodiment of this application. As shown in FIG. 5, the method for determining a user plane provided in this embodiment of this application may include the following step 301 and step 302.

Step 301: A third network element sends a query request to a second network element.

In this embodiment of this application, the query request is used to request the second network element to search for/discover a first network element, the query request includes second target indication information, and the second target indication information is used to indicate the first network element that meets a target condition.

Step 302: The second network element receives the query request sent by the third network element.

In some implementations, the third network element may be an SMF network element, or may be another 5G core network element. This is not limited in this embodiment of this application.

In some implementations, the third network element triggers the query request of the first network element to use Nnrf_NFDiscovery_Request.

In some implementations, the query request includes at least one of the following: indicating whether to search for the service-based first network element; and indicating to search for the first network element with a specified capability, that is, provide a corresponding event ID. For example, when searching for the first network element, the third network element may instruct to search for one first network element that can provide quality of service QoS monitoring (monitoring) through a serving interface; and indicate that the first network element may also use service-based information of another 5G network element.

For example, an SMF network element triggers a network element search request to an NRF network element: Nnrf_NFDiscovery_Request. The search request may request the NRF network element to search for a service-based UPF network element. The service-based UPF network element can expose QoS monitoring to another network element through Nupf_EventExposure_Notify.

For another example, an NWDAF network element triggers a network element search request Nnrf_NFDiscovery_Request to an NRF network element. The search request may request the NRF network element to search for a service-based UPF network element. The query request includes: Event ID=QOS flow Packet Delay, that is, the service-based UPF network element can expose the QoS flow packet delay to another network element through Nupf_EventExposure_Notify.

In some implementations, the first network element that meets the target condition includes at least one of the following: a service-based first network element, a first network element that has a target capability, and a first network element that can use service-based information of another network element.

In some implementations, the first network element that has the target capability is a first network element that can expose a related service. The related service of the first network element includes at least one of the following: a quality of service QoS flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, and QoS monitoring indication information of the first network element. The first device is the first network element or user equipment UE, and the QoS monitoring indication information is used to indicate whether the first network element can provide QoS monitoring through service-based signaling.

In some implementations, the first network element provides the related service of the first network element through service-based signaling, and the service-based signaling includes at least one of the following notification information: Nupf_EventExposure_Notify. It should be noted that for descriptions of each service in the related service of the first network element, refer to the descriptions of the foregoing embodiment. Details are not described herein again.

In some implementations, with reference to FIG. 5, as shown in FIG. 6, after the foregoing step 302, the method for determining a user plane provided in this embodiment of this application further includes the following step 303 and step 304.

Step 303: The second network element sends a query response to the third network element.

In this embodiment of this application, the query response includes an Internet Protocol IP address, a port number, or a fully qualified domain name FQDN of a user plane network element that meets the target condition.

Step 304: The third network element receives the query response sent by the second network element.

This embodiment of this application further provides the method for determining a user plane. The third network element may request, through the query request, the second network element to search for the first network element. Because the query request includes the second target indication information indicating the first network element that meets the target condition, the second network element can quickly and accurately discover the first network element that meets the target condition (that is, meets a requirement of the third network element).

It should be noted that, the method for determining a user plane provided in this embodiment of this application may be performed by an apparatus for determining a user plane, or a control module that is in the apparatus for determining a user plane and that is configured to perform the method for determining a user plane.

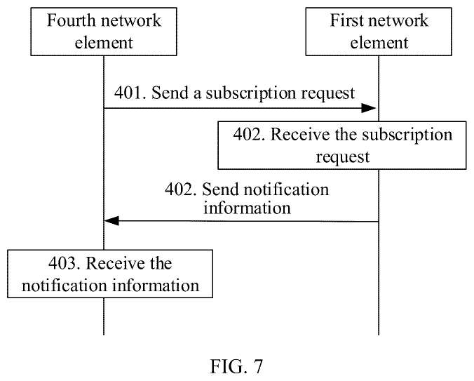

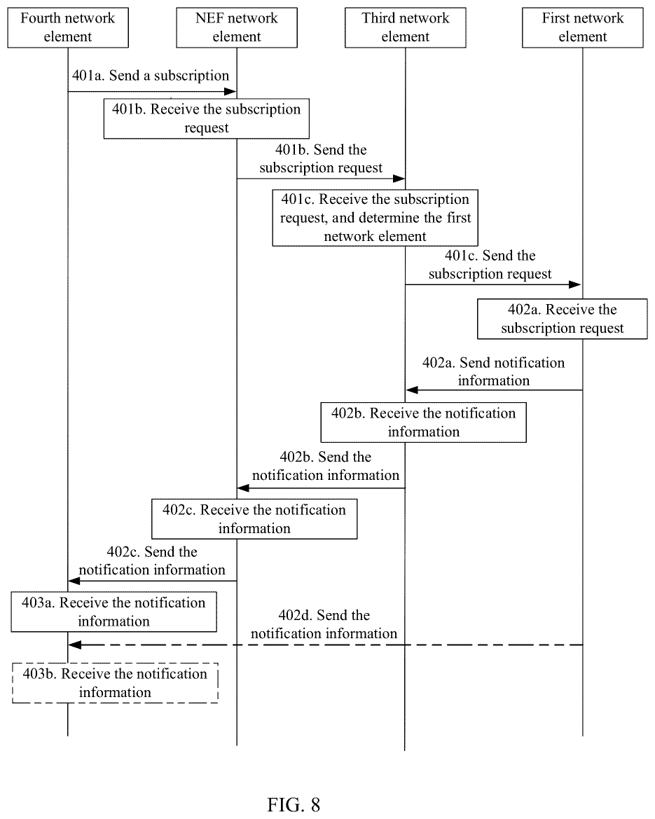

An embodiment of this application further provides a method for subscribing to user plane service information. FIG. 7 is a flowchart of a method for subscribing to user plane service information according to an embodiment of this application. As shown in FIG. 7, the method for subscribing to user plane service information provided in this embodiment of this application may include the following steps 401 to 403.

Step 401: A fourth network element sends a subscription request to a first network element.

In this embodiment of this application, the subscription request is used to request to subscribe to a related service of the first network element, and the subscription request includes related information of the first network element.

In some implementations, the fourth network element may be an AF network element or an NWDAF network element.

For example, the AF network element or the NWDAF network element may subscribe to a related service of a UPF network element (that is, the first network element) through Nupf_EventExposure_Subscribe.

Step 402: The first network element receives the subscription request sent by the fourth network element, and sends notification information to the fourth network element.

In this embodiment of this application, the notification information includes the related service of the first network element.

In this embodiment of this application, after receiving the subscription request sent by the fourth network element, the first network element agrees to the subscription request, and after obtaining the related service that is of the first network element and that is requested by the subscription request, the first network element may send the notification information to the fourth network element, so as to send the related service of the first network element to the fourth network element.

For example, the AF network element requests the UPF network element to collect a QoS monitoring report. After collecting related information, the UPF network element sends the QoS monitoring report to the AF network element through Nupf_EventExposure_Notify.

Step 403: The fourth network element receives the notification information sent by the first network element.

In some implementations, the first network element provides the related service of the first network element through service-based signaling, and the service-based signaling includes at least one of the following notification information: Nupf_EventExposure_Notify.

In some implementations, the related information of the first network element includes at least one of the following: an Internet Protocol IP address of UE, a subscription permanent identifier SUPI or a generic public subscription identifier GPSI of the UE, a data network name DNN of the UE, single network slice selection assistance information S-NSSAI of the UE, the related service that is of the first network element and that is requested for subscription, a related service supported by the first network element, and fourth indication information, where the fourth indication information is used to instruct the first network element that requests service orientation to provide the related service of the first network element.

In some implementations, the first network element that requests service orientation directly provides a notification for the fourth network element via a local NEF network element or the NEF network element. Instead of a control plane, a user plane must directly provide an information indication.

In some implementations, the related service of the first network element includes at least one of the following: a quality of service QoS flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, and QoS monitoring indication information of the first network element. The first device is the first network element or user equipment UE, and the QoS monitoring indication information is used to indicate whether the first network element can provide QoS monitoring through service-based signaling.

In some implementations, the first network element provides the related service of the first network element through service-based signaling, and the service-based signaling includes at least one of the following notification information: Nupf_EventExposure_Notify.

It should be noted that for descriptions of each service in the related service of the first network element, refer to the descriptions of the foregoing embodiment. Details are not described herein again.

In some implementations, in manner 1 of this embodiment of this application, the fourth network element is an AF network element, and the AF network element indirectly subscribes to a related service of a UPF network element through an SMF network element. With reference to FIG. 7, as shown in FIG. 8, the foregoing step 401 may be specifically implemented by the following step 401a to step 401c; the foregoing step 402 may be specifically implemented by the following step 402a to step 402c, or the foregoing step 402 may be specifically implemented by the following step 402d; and the foregoing step 403 may be specifically implemented by the following step 403a or step 403b.

Step 401a: The fourth network element sends a subscription request to an NEF network element.

In this embodiment of this application, the subscription request is used by the third network element to determine the first network element.

For example, the AF network element sends a subscription request Nnef_EventExposure_Subscribe to the NEF network element, and the subscription request is used to subscribe to the related service of the UPF network element (that is, the first network element). In this case, there is a PDU session between the AF network element and UE. However, the AF network element does not know who the UPF network element serving the current UE is. Therefore, a user plane network element needs to be first determined.

Step 401b: The NEF network element receives the subscription request sent by the fourth network element, and sends the subscription request to the third network element.

For example, after receiving the subscription request from the AF network element, the NEF network element first needs to discover an SMF network element that manages the PDU session between the AF network element and the UE. Then, the NEF network element may send a subscription request Nsmf_EventExposure_Subscribe to the SMF network element. The subscription request is used to subscribe the related service of the UPF network element that maintains the PDU session between the current AF network element and the UE. For example, if Nsmf_EventExposure_Subscribe may carry Event ID=UPF throughput, it indicates that the UPF network element is expected to provide throughput data of the UPF network element.

In some implementations, the NEF network element triggers a subscription such as Nsmf_EventExposure_Subscribe request to the third network element. However, this request needs to be added to subscribe to an event of the first network element, including an event ID of the first network element.

Step 401c: The third network element receives the subscription request sent by the NEF network element, determines the first network element, and sends the subscription request to the first network element.

In some implementations, after receiving the request from the NEF, the third network element can discover the PDU session according to a UE IP address, an SUPI, and the like, discover an IP address of the UPF that carries the PDU session, and then trigger a subscription request Nupf_EventExposure_Subscribe to the UPF. The subscription request is used to obtain exposure information (that is, information corresponding to an event ID) of the first network element that the fourth network element hopes to obtain, and is mainly used to send the event ID to the first network element.

It can be understood that the fourth network element sends the subscription request to the third network element through the NEF network element, and the fourth network element sends the subscription request to the first network element through the third network element.

Step 402a: The first network element receives the subscription request sent by the third network element, and sends notification information to the third network element.

For example, the UPF network element sends Nupf_EventExposure_Notify to the SMF network element, and this piece of signaling includes the related information of the UPF network element (that is, the first network element) to which the AF network element subscribes.

Step 402b: The third network element receives the notification information sent by the first network element, and sends the notification information to the NEF network element.

For example, the SMF network element sends Nsmf_EventExposure_Notify to the NEF network element, and this piece of signaling includes the related information of the UPF network element (that is, the first network element) to which the AF network element subscribes.

Step 402c: The NEF network element receives the notification information sent by the third network element, and sends the notification information to the fourth network element.

For example, the NEF network element sends Nnef_EventExposure_Notify to the AF network element, and this piece of signaling includes the related information of the UPF network element (that is, the first network element) to which the AF network element subscribes.

It can be understood that the fourth network element receives the notification information sent by the first network element through the third network element and the NEF network element.

Step 402d: The first network element directly sends the notification information to the fourth network element.

It can be understood that the first network element may directly send a result of a provided service to a subscriber. For example, the UPF network element collects UPF throughput information according to the subscription request of the AF network element, and then the UPF network element directly sends the information to the AF network element.

For example, the UPF network element sends Nupf_EventExposure_Notify to the NEF network element, and this piece of signaling includes the related information of the UPF network element (that is, the first network element) to which the AF network element subscribes. Then the NEF network element triggers Nnef_EventExposure_Notify to the AF network element, and this piece of signaling includes the related information of the UPF network element to which the AF network element subscribes. Herein, the NEF network element serves only as a forwarding function and does not process signaling. In this way, the UPF network element directly sends the collected related information of the first network element to the AF network element without being forwarded by another control plane network element such as the SMF network element.

Step 403a: The fourth network element receives the notification information sent by the NEF network element.

Step 403b: The fourth network element directly receives the notification information sent by the first network element.

It can be understood that in a case that the foregoing step 402a to step 402c are performed, the foregoing step 403a is performed, and in a case that the foregoing step 402d is performed, the foregoing step 403b is performed.

It should be noted that the foregoing step 402a to step 402c are in an “OR” relationship with the foregoing step 402d, and the foregoing step 403a and step 403b are also in an “OR” relationship. To illustrate this relationship, step 402d and step 403b are shown by using dashed lines in FIG. 8.

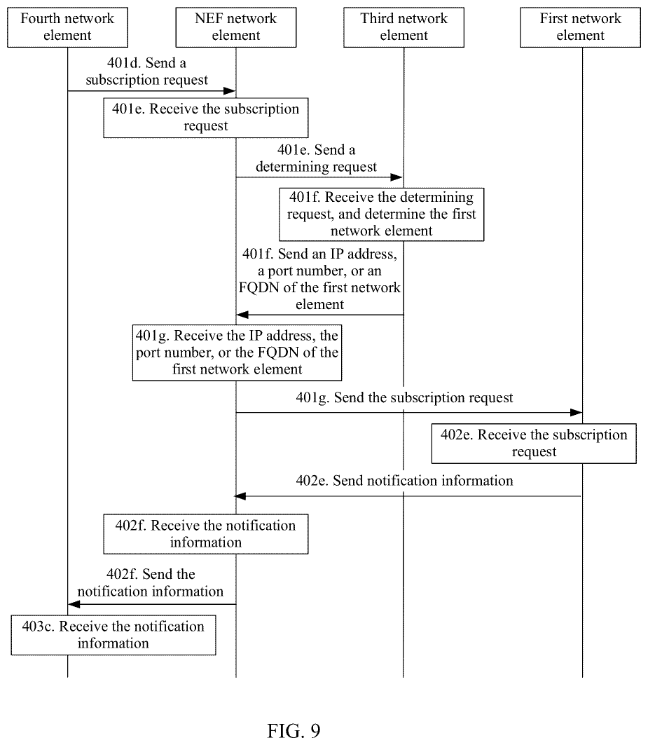

In some implementations, in manner 2 of this embodiment of this application, the fourth network element is an AF network element, and the AF network element directly subscribes to a related service of a UPF network element. With reference to FIG. 7, as shown in FIG. 9, the foregoing step 401 may be specifically implemented by the following step 401d to step 401g, the foregoing step 402 may be specifically implemented by the following step 402e and step 402f, and the foregoing step 403 may be specifically implemented by the following step 403c.

Step 401d: The fourth network element sends a subscription request to an NEF network element.

For example, the AF network element sends a subscription request Nnef_EventExposure_Subscribe to the NEF network element, and the subscription request is used to subscribe to the related service of the UPF network element. In this case, there is a PDU session between the AF network element and UE. However, the AF network element does not know who the UPF network element serving the current UE is. Therefore, a user plane network element needs to be first determined.

Step 401e: The NEF network element receives the subscription request sent by the fourth network element, and sends a determining request to the third network element.

It should be noted that a prerequisite for the NEF network element to send the determining request to the third network element is that the NEF network element discovers the third network element. The determining request is used to determine the UPF network element that currently serves the PDU session between the AF network element and the UE.

For example, after receiving the subscription request from the AF network element, the NEF network element first needs to discover an SMF network element that manages the PDU session between the AF network element and the UE. Then the NEF network element sends a request Nsmf_UPFInformation_Get to the SMF network element. This piece of signaling is used to request to obtain information about the UPF network element serving the PDU session between the current AF network element and the UE, and the piece of signaling further includes parameters such as an IP address of the UE, an SUPI or a GPSI of the UE, a DNN of the UE, S-NSSAI of the UE, the related service that is of the first network element and that is requested for subscription, a related service supported by the first network element, and fourth indication information, where the fourth indication information is used to instruct the first network element that requests service orientation to provide the related service of the first network element.

In this embodiment of this application, the determining request is used by the third network element to determine the first network element, and the determining request includes an IP address, a port number, or an FQDN of the first network element.

It can be understood that in this embodiment of this application, after the NEF network element discovers the third network element, the NEF needs to replace the fourth network element to discover the first network element that serves the current UE and the current PDU session.

Step 401f: The third network element receives the determining request sent by the NEF network element, determines the first network element, and sends an IP address, a port number, or an FQDN of the first network element to the NEF network element.

Step 401g: The NEF network element receives the IP address, the port number, or the FQDN of the first network element sent by the third network element, and sends the subscription request to the first network element.

It can be understood that the fourth network element sends the subscription request to the NEF network element, and sends the determining request to the third network element according to the subscription request through the NEF network element to determine address information of the first network element. In addition, the fourth network element sends the IP address, the port number, or the FQDN of the first network element to the NEF network element through the third network element, and sends the subscription request to the first network element through the NEF network element.

It can be understood that instead of the fourth network element, the NEF network element triggers a subscription to the first network element.

Step 402e: The first network element receives the subscription request sent by the NEF network element, and sends notification information to the NEF network element.

For example, instead of the AF network element, the NEF network element sends a subscription request Nupf_EventExposure_Subscribe to the UPF network element, and the subscription request is used to subscribe to the related service of the UPF network element (that is, the first network element).

Step 402f: The NEF network element receives the notification information sent by the first network element, and sends the notification information to the fourth network element.

For example, the UPF network element sends Nupf_EventExposure_Notify to the NEF network element, and this piece of signaling includes the related information of the UPF network element (that is, the first network element) to which the AF network element subscribes. Then, the NEF network element triggers Nnef_EventExposure_Notify to the AF network element, and this piece of signaling includes the related information of the UPF network element (that is, the first network element) to which the AF network element subscribes. Herein, the NEF network element serves only as a forwarding function and does not process signaling. In this way, the UPF network element directly sends the collected related information of the first network element to the AF network element without being forwarded by another control plane network element such as the SMF network element.

In some implementations, the NEF network element triggers a subscription request Nupf_EventExposure_Subscribe to the first network element. The subscription request is used to obtain exposure information (that is, information corresponding to an event ID) of the first network element that the fourth network element hopes to obtain.

Step 403c: The fourth network element receives the notification information sent by the NEF network element.

For example, after receiving the notification sent by the UPF network element, the NEF network element triggers Nnef_EventExposure_Notify to the AF network element, and this piece of signaling includes the related information of the UPF network element (that is, the first network element) to which the AF network element subscribes. Herein, the NEF network element serves only as a forwarding function and does not process signaling. In this way, the UPF network element directly sends the collected related information of the first network element to the AF network element without being forwarded by another control plane network element such as the SMF network element.

It can be understood that the fourth network element receives the notification information sent by the first network element through the NEF network element.

In some implementations, the first network element provides the related service of the first network element through service-based signaling, and the service-based signaling includes at least one of the following notification information: Nupf_EventExposure_Notify.

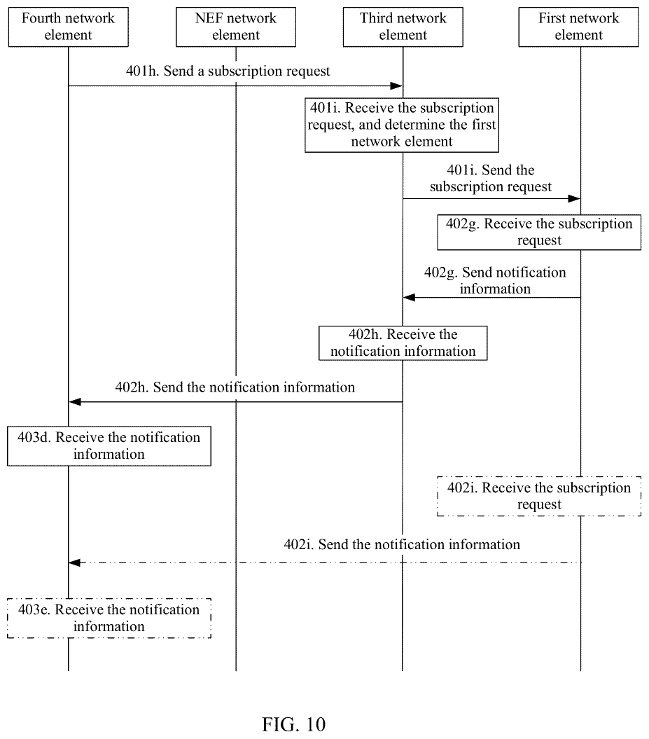

In some implementations, in manner 3 of this embodiment of this application, the fourth network element is an NWDAF network element, and the NWDAF network element indirectly subscribes to a related service of a UPF network element through an SMF network element. With reference to FIG. 7, as shown in FIG. 10, the foregoing step 401 may be specifically implemented by the following step 401h and step 401i; the foregoing step 402 may be specifically implemented by the following step 402g and step 402h, or the foregoing step 402 may be specifically implemented by the following step 402i; and the foregoing step 403 may be specifically implemented by the following step 403d or step 403e.

Step 401h: The fourth network element sends a subscription request to the third network element.

In some implementations, a network element (for example, an SMF network element or an AMF network element) requests an analytics result of the third network element through signaling Nnwdaf_AnalyticsSubscription_Subscribe or Nnwdaf_AnalyticsInfo_Request, where the signaling carries parameters: Analytics ID=UE communication (or another Analytics ID of the NWDAF network element in manner 1 of this embodiment), Target of Analytics Reporting=SUPI, and Analytics Filter Information=(Application ID, Area of Interest, etc.).

In some implementations, the fourth network element may directly first discover the third network element, and then trigger a subscription. In this case, the NEF network element is not used.

In some implementations, the fourth network element discovers, through an SUPI, the third network element serving UE (which is actually the third network element serving a PDU session of the UE), to obtain an ID of the third network element, an IP address of the third network element, and the like.

In this embodiment of this application, the subscription request is used by the third network element to determine the first network element.

In some implementations, the fourth network element triggers a subscription request: Nsmf_EventExposure_Subscribe (an event ID, an SUPI, and an application ID), and expects the third network element to provide the related information of the first network element. Herein, the event ID is exposure information that can be provided by the first network element. In addition, an indication (indication) may be carried herein, indicating that the first network element is requested to provide the exposure information through the third network element. In addition, the fourth network element may further indicate whether to enable the first network element that has a serving capability to expose information.

For example, the fourth network element (for example, an NWDAF network element) sends a subscription request Nsmf_EventExposure_Subscribe to the SMF network element. The subscription request is used to subscribe to a related service of a UPF network element in a PDU session of current UE. For example, if Nsmf_EventExposure_Subscribe may carry Event ID-UPF throughput, it indicates that the UPF network element is expected to provide throughput data of the UPF network element. A UE IP address, a DNN, S-NSSAI, an SUPI, and the like may also be carried. The foregoing information is used by the third network element to determine the UPF network element (the first network element).

Step 401i: The third network element receives the subscription request sent by the fourth network element, determines the first network element, and sends the subscription request to the first network element.

For example, after determining an IP address or a port number of the UPF network element, the SMF network element sends a subscription request Nupf EventExposure_Subscribe to the UPF network element. The subscription request is used to subscribe to the related information of the first network element. The related information is exposure information that the NWDAF network element expects the first network element to provide in the foregoing step 401h, that is, exposure information corresponding to an event ID.

It can be understood that the fourth network element sends the subscription request to the third network element, so as to send the subscription request to the first network element through the third network element.

Step 402g: The first network element receives the subscription request sent by the third network element, and sends notification information to the third network element.

For example, the UPF network element sends Nupf_EventExposure_Notify to the SMF network element, and this piece of signaling includes the related information of the UPF network element (that is, the first network element) to which the NWDAF network element subscribes.

Step 402h: The third network element receives the notification information sent by the first network element, and sends the notification information to the fourth network element. For example, the SMF network element sends Nsmf_EventExposure_Notify to the NWDAF network element, and this piece of signaling includes the related information of the UPF network element (that is, the first network element) to which the NWDAF network element subscribes.

Step 402i: The first network element receives the subscription request sent by the third network element, and directly sends the notification information to the fourth network element.

For example, the UPF network element sends Nupf_EventExposure_Notify to the NWDAF network element, and this piece of signaling includes the related information of the UPF network element (that is, the first network element) to which the NWDAF network element subscribes.

In some implementations, the third network element discovers the first network element, and sets an N4 interface reporting rule. After collecting data, the first network element may expose information to the fourth network element if a reporting condition is met.

Step 403d: The fourth network element receives the notification information sent by the third network element.

It can be understood that the fourth network element receives the notification information sent by the first network element through the third network element.

Step 403e: The fourth network element directly receives the notification information sent by the first network element.

In some implementations, the first network element provides the related service of the first network element through service-based signaling, and the service-based signaling includes at least one of the following notification information: Nupf_EventExposure_Notify.

In some implementations, the notification information is sent by the first network element in a case that the related service of the first network element is exposed.

It can be understood that in a case that the foregoing step 402g and step 402h are performed, the foregoing step 403d is performed, and in a case that the foregoing step 402i is performed, the foregoing step 403c is performed.

It should be noted that the foregoing step 402g and step 402h are in an “OR” relationship with the foregoing step 402i, and the foregoing step 403d and step 403c are also in an “OR” relationship. To illustrate this relationship, step 402i and step 403e are shown by using dashed lines in FIG. 10.

In some implementations, the subscription request further includes at least one of the following: fifth indication information and sixth indication information, where the fifth indication information is used to instruct to request, through the third network element, the first network element to expose the related service of the first network element, and the sixth indication information is used to indicate whether to allow a user plane network element that has a service-based capability to expose a related service.

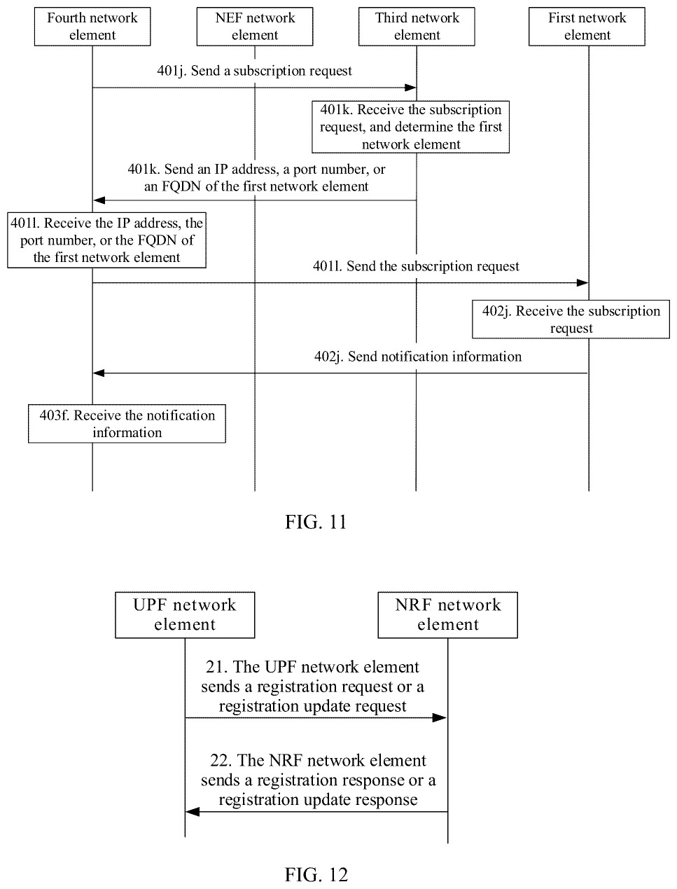

In some implementations, in manner 4 of this embodiment of this application, the fourth network element is an NWDAF network element, and the NWDAF network element directly subscribes to the related service of the UPF network element. With reference to FIG. 7, as shown in FIG. 11, the foregoing step 401 may be specifically implemented by the following step 401j to step 401l, the foregoing step 402 may be specifically implemented by the following step 402j, and the foregoing step 403 may be specifically implemented by the following step 403f.

Step 401j: The fourth network element sends a subscription request to the third network element.

In some implementations, a network element (for example, an SMF network element or an AMF network element) requests an analytics result of the third network element through signaling Nnwdaf_AnalyticsSubscription_Subscribe or Nnwdaf_AnalyticsInfo_Request, where the signaling carries parameters: Analytics ID=UE communication (or another Analytics ID of the NWDAF network element in manner 1 of this embodiment), Target of Analytics Reporting=SUPI, and Analytics Filter Information=(Application ID, Area of Interest, etc.).

In some implementations, the fourth network element discovers, through an SUPI, a UE IP, a DNN, and/or S-NSSAI, the third network element serving the UE (which is actually the third network element serving a PDU session of the UE), to obtain an ID of the third network element, an IP address of the third network element, and the like (for example, an ID, an IP address, and the like of the SMF network element are obtained).

In this embodiment of this application, the subscription request is used by the third network element to determine the first network element.

For example, the NWDAF network element requests, by sending the SUPI, the UE IP, the DNN, and/or the S-NSSAI, the SMF network element to discover information such as an IP address and a port number of the UPF that serve a PDU session of the current UE.

In some implementations, the fourth network element triggers the request to obtain an IP address of the first network element, so as to subscribe to and obtain information about the first network element.

For example, the fourth network element triggers a request, and expects to obtain the related information of the first network element from the SMF, for example, through Nsmf_UPFInformation_Get, where parameters include an SUPI, a DNN, and S-NSSAI of the UE. The information is used to obtain the IP address of the first network element serving the current UE.

In addition, the fourth network element may further indicate whether to enable the first network element that has a serving capability to expose information.

Step 401k: The third network element receives the subscription request sent by the fourth network element, determines the first network element, and sends an IP address, a port number, or an FQDN of the first network element to the fourth network element.

For example, the third network element sends the IP address, the port number, or the FQDN of the first network element to the NWDAF network element through Nsmf_UPFInformation_Get response.

Step 401l: The fourth network element receives the IP address, the port number, or

the FQDN of the first network element sent by the third network element, and sends the subscription request to the first network element.

For example, the NWDAF network element triggers Nupf EventExposure_Subscribe to the UPF network element. The subscription request is used to subscribe to the related information of the first network element. The related information is exposure information that the NWDAF network element expects the first network element to provide, that is, exposure information corresponding to an event ID.

Step 402j: The first network element receives the subscription request sent by the fourth network element, and directly sends notification information to the fourth network element.

In some implementations, the fourth network element subscribes to the event by uisng Nupf_EventExposure_Subscribe, and parameters include an event ID, a UE IP, an SUPI, a DNN, S-NSSAI, and the like.

In some implementations, after collecting the data expected by the first network element, the first network element sends a notify (notification) to the fourth network element.

Step 403f: The fourth network element directly receives notification information sent by the first network element.

In some implementations, the first network element provides the related service of the first network element through service-based signaling, and the service-based signaling includes at least one of the following notification information: Nupf_EventExposure_Notify.

This embodiment of this application provides the method for subscribing to user plane service information. In a case that a third network element discovers the first network element, the fourth network element may directly or indirectly send the subscription request to the first network element to subscribe to the related service of the first network element, that is, may directly subscribe to the related service of the first network element, or indirectly subscribe to the related service of the first network element through the third network element, so as to obtain, from the first network element, the related service exposed by the first network element.

It should be noted that, the method for subscribing to user plane service information provided in this embodiment of this application may be performed by an apparatus for subscribing to user plane service information, or a control module that is in the apparatus for subscribing to user plane service information and that is configured to perform the method for subscribing to user plane service information.

In some implementations, an execution relationship between the foregoing step 201 and step 202, step 301 and step 302, and step 401 to step 403 may be: The foregoing step 201 and step 202 are performed first, then step 301 and step 302 are performed, and then step 401 to step 403 are performed; or the foregoing step 201 and step 202 may be performed first, then step 401 to step 403 are performed, and step 301 and step 302 are performed in a process of performing step 401 to step 403. It can be understood that the first network element may send the target request to the second network element, to request to register the first network element to the second network element; in a case that the first network element registers with the second network element, the third network element may send the query request to the second network element, to request the second network element to search for the first network element; and in a case that the third network element discovers the first network element through the second network element, the fourth network element may send the subscription request to the first network element, to request to subscribe to the related service of the first network element.

The following describes in detail, by using specific implementations (that is, Implementation 1 to Implementation 3), interaction processes of the method for registering a service-based user plane, the method for determining a user plane, and the method for subscribing to user plane service information provided in the embodiments of this application.

Implementation 1: A method/process for registering a service-based user plane.

As shown in FIG. 12, the method for registering a service-based user plane provided in this embodiment of this application includes the following step 21 and step 22.

Step 21: A UPF network element sends a registration request or a registration update request to an NRF network element.

In this embodiment of this application, the UPF network element may trigger a registration request (Nnrf_NFManagement_NFRegister Request) or a registration update request (Nnrf_NFManagement_NFUpdate Request) to the NRF network element, to request the NRF network element to register related information of the UPF network element in the NRF network element, where the NRF network element is a network element that is in a 5G core network and that is configured to search for a network element.

The registration request or the registration update request includes at least one of the following:
one piece of indication information, where the indication information is used to indicate whether the UPF network element is a service-based UPF, and the following several types of analysis are included:
(a) It indicates whether the user plane can expose a related service to other network elements, such as an AMF network element, an SMF network element, an NEF network element, an AF network element, and an NWDAF network element. A service that can be exposed by the UPF network element includes at least one of the following, and each piece of information or each service that can be exposed uses an event identifier ID:
a QoS flow bit rate (per UE or per UPF);
a QoS flow packet delay (per UE or per UPF);
packet transmission (per UE or per UPF);
packet retransmission (per UE or per UPF);
a UPF resource: a resource status of the UPF;
a UPF load: a load status of the UPF in a time interval;
a UPF traffic volume: a traffic volume of the UPF;
a UPF throughput: an uplink or downlink throughput; and
QoS monitoring: whether the UPF can provide QoS monitoring.
(b) The UPF may indicate whether information or a capability in the foregoing (a) can be directly subscribed, or needs to be indirectly subscribed through an SMF. If the information can be directly subscribed, a subscriber directly triggers Nupf_EventExposure_Subscribe to the UPF. If the information cannot be directly subscribed, an event of the UPF needs to be subscribed through the SMF.
(c) The UPF may further indicate whether the UPF can obtain a service of another 5GC core network. For example, the UPF may indicate that the UPF can obtain a service of an SMF, a PCF, or an NWDAF.

Step 22: After the NRF completes UPF registration, the NRF triggers/sends a registration response or a registration update response to the UPF, to indicate that current registration or registration update is completed.

It should be noted that for related descriptions and beneficial effects of the foregoing step 21 and step 22, refer to the descriptions of the foregoing embodiment. Details are not described herein again.

Implementation 2: A method/process for determining a user plane is selecting a UPF network element according to whether a UPF network element has a service-based or service exposure capability.

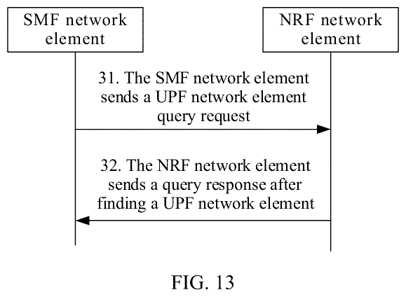

As shown in FIG. 13, the method for determining a user plane provided in this embodiment of this application includes the following step 31 and step 32.

Step 31: An SMF network element triggers/sends a UPF query request.

In this embodiment of this application, the query request (Nnrf_NFDiscovery_Request) includes at least one of the following information:
one piece of indication information, where the indication information is used to indicate whether to search for a service-based UPF;
one piece of indication information indicating to search for a UPF with a specified capability, that is, provide a corresponding event (event) ID, where for example, when searching for a UPF, the SMF may instruct to search for a UPF that can provide QoS monitoring (monitoring) through a service-based interface; and
indication information, where the indication information is used to indicate that the UPF may also use service-based information of another 5GC network element.

Step 32: After an NRF discovers a UPF, the NRF network element triggers/sends a query response to the SMF network element.

In this embodiment of this application, the query response (Nnrf_NFDiscovery response) includes an IP address of the UPF network element that meets a condition, an ID of the UPF, or an FQDN of the UPF network element.

It should be noted that, in Implementation 2, that the SMF network element selects/searches for the UPF network element is used as an example for description. However, in addition to the SMF network element, another service-based network element (for example, an AMF network element or a PCF network element) may also complete selection/searching of the UPF network element.

For related descriptions and beneficial effects of the foregoing step 31 and step 32, refer to the descriptions of the foregoing embodiment. Details are not described herein again.

Implementation 3: A method/process for subscribing to user plane service information is: an AF network element or an NWDAF network element subscribe to a related service of a UPF network element.

For Implementation 3, the following describes in detail, by using four implementations (that is, Implementation 3.1 to Implementation 3.4), an interaction process of the method for subscribing to user plane service information provided in this embodiment of this application.

Implementation 3.1: An AF indirectly subscribes to a related service of an UPF through an SMF.

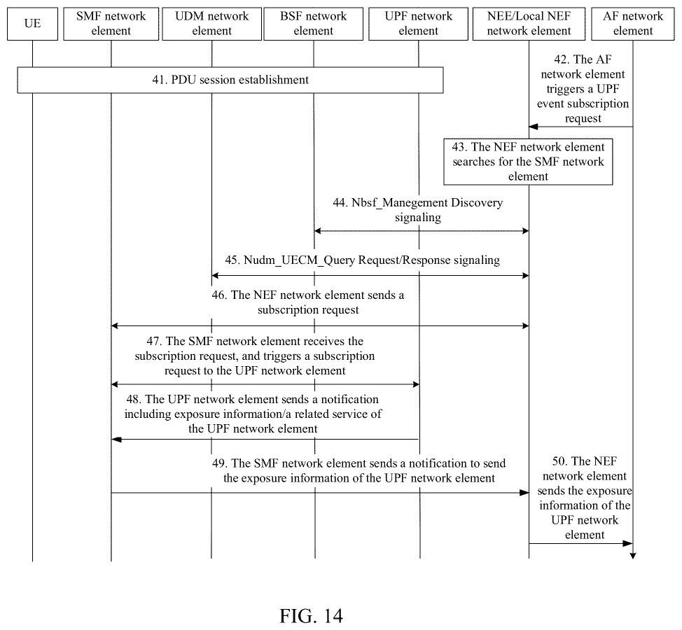

As shown in FIG. 14, the method for subscribing to user plane service information provided in this embodiment of this application includes the following step 41 to step 50. Step 41: Establish a PDU session.

In this embodiment of this application, PDU session establishment (PDU Session Establishment) is between UE and a UPF, and a session between the UPF and an AF is also established.

Step 42: The AF triggers a UPF event subscription request (UPF event subscription), where the subscription request is used to subscribe to a related service of the UPF.

In this embodiment of this application, the subscription request includes at least one of the following:
a UE IP address;
a UE SUPI or GPSI;
a DNN;
S-NSSAI;
to-be-subscribed event or information of the UPF, represented by an event ID; and
indication information, requesting the service-based UPF to directly provide a notification for the AF or an NEF, where instead of a control plane, a user plane must directly provide an information indication of the UPF.

Step 43 to step 45: The NEF searches for the SMF, that is, discovers one SMF, where the SMF is a management network element of the PDU session.

Step 46: The NEF triggers a subscription request such as Nsmf_EventExposure_Subscribe request to the SMF.

It should be noted that the subscription request subscribes to an event of the UPF, including an event ID of the UPF.

Step 47: After receiving the subscription request of the NEF, the SMF can discover the PDU session according to the UE IP address, the SUPI, and the like, discover an IP address of the UPF that carries the PDU session, and then trigger a subscription request (Nupf EventExposure_Subscribe) to the UPF.

The subscription request is used to obtain exposure information (information/service corresponding to the event ID) of the UPF that the AF/NWDAF expects to obtain, that is, the subscription request includes the event ID of the exposure information of the UPF that the AF/NWDAF expects to obtain.

Step 48: The UPF sends a notification (notification) to the SMF, where the notification includes the exposure information/related service of the UPF.

Step 49: The SMF sends a notification to the NEF, to send the exposure information of the UPF to the NEF.

Step 50: The NEF sends the exposure information of the UPF to the AF.

It should be noted that for related descriptions and beneficial effects of the foregoing step 41 to step 50, refer to the descriptions of the foregoing embodiment. Details are not described herein again.

Implementation 3.2: An AF network element directly subscribes to a related service of a UPF network element.

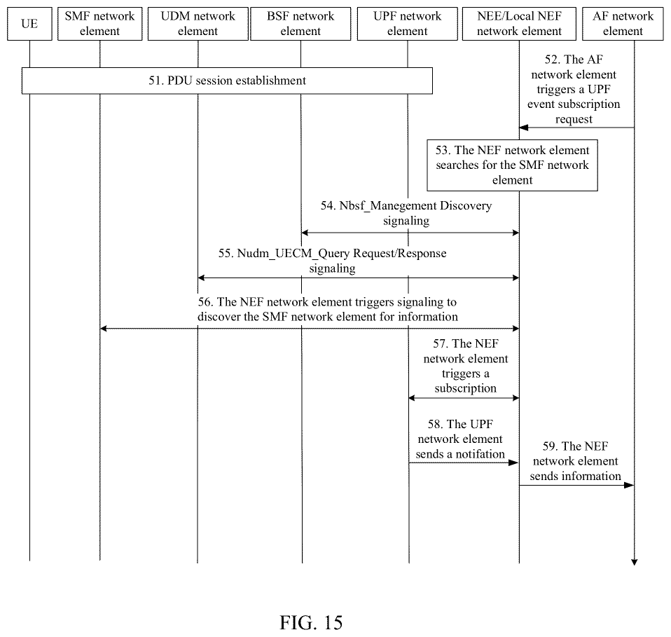

As shown in FIG. 15, the method for subscribing to user plane service information provided in this embodiment of this application includes the following step 51 to step 59.

Step 51 to step 55 are the same as step 41 to step 45.

It should be noted that after the NEF discovers the SMF, the NEF may replace the AF to discover the UPF network element that serves the current UE and the current PDU session.

Therefore, in step 56, the NEF network element triggers one piece of signaling to discover the SMF network element for a current UE IP, a DNN, S-NSSAI, and an SUPI, an event ID (information exposed by the UPF network element), and information about the corresponding UPF network element. In one implementation, this piece of signaling is an event exposure (exposure) service-based message of the SMF network element.

New Nsmf_UPFInformation_Get may also be designed.

SMF Response: An IP address of the UPF network element, a UPF ID, and a UPF FQDN are sent to the NEF network element. The UPF network element must be a UPF that serves the current UE and the current PDU session and can provide capability exposure information corresponding to the event ID.

Step 57: The NEF network element triggers a subscription to the UPF network element in place of the AF network element.

A subscription request Nupf_EventExposure_Subscribe is triggered to the UPF network element, where the subscription request is used to obtain exposure information (information corresponding to the event ID) of the UPF network element that the AF network element expects to obtain. Step 58: The UPF network element sends a notification to the NEF network element, to send exposure information.

Step 59: The NEF network element sends the information to the AF.

It should be noted that for related descriptions and beneficial effects of the foregoing step 51 to step 59, refer to the descriptions of the foregoing embodiment. Details are not described herein again.

Implementation 3.3: An NWDAF network element indirectly subscribes to a related service of a UPF network element through an SMF network element.

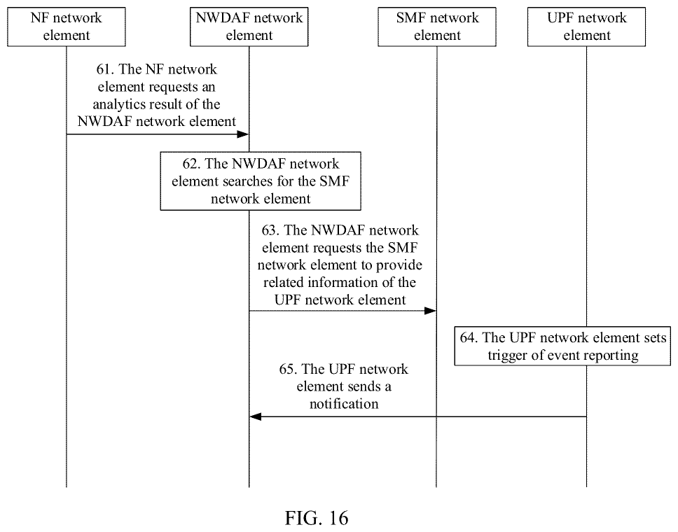

As shown in FIG. 16, the method for subscribing to user plane service information provided in this embodiment of this application includes the following steps 61 to 65.

It should be noted that the procedure herein is similar to the foregoing procedure in which the AF network element indirectly subscribes to the related service of the UPF through the SMF network element. A difference lies in that the NWDAF network element may directly discover the SMF network element (that is, the NEF network element does not need to be used), and then trigger a subscription to the related service of the UPF network element.

Step 61: An NF network element requests an analytics result of an NWDAF network element through signaling Nnwdaf_AnalyticsSubscription_Subscribe, where the signaling carries parameters. Analytics ID=UE communication (or another Analytics ID of the NWDAF network element in Embodiment 1), Target of Analytics Reporting=SUPI, and Analytics Filter Information=(Application ID, Area of Interest, etc.).

Step 62: The NWDAF network element may use an SUPI to discover, according to step 4 to step 5 in Embodiment 3-1, an SMF network element that serves UE (which is actually an SMF network element that serves a PDU session of the UE), to obtain an SMF ID, an SMF IP address, and the like.

Step 63: Nsmf_EventExposure_Subscribe (an event ID, an SUPI, and an application ID).

The NWDAF network element triggers a request, to expect the SMF network element to provide related information of a UPF network element. Herein, the event ID is exposure information that the UPF network element can provide. In addition, an indication (indication) may be carried, and the indication requests the UPF network element to provide the exposure information through the SMF network element.

In addition, the NWDAF network element may further indicate whether to enable the UPF network element that has a serving capability to expose information.

Step 64: The SMF network element discovers the UPF network element and sets an N4 reporting rule. After collecting data, the UPF network element may expose information to the NWDAF network element if a reporting condition is met.

Step 65: The UPF network element notifies the NWDAF network element that information corresponding to the event ID is obtained and send the information to the NWDAF network element.

It should be noted that for related descriptions and beneficial effects of the foregoing step 61 to step 65, refer to the descriptions of the foregoing embodiment. Details are not described herein again.

Implementation 3.4: An NWDAF directly subscribes to a related service of a UPF.

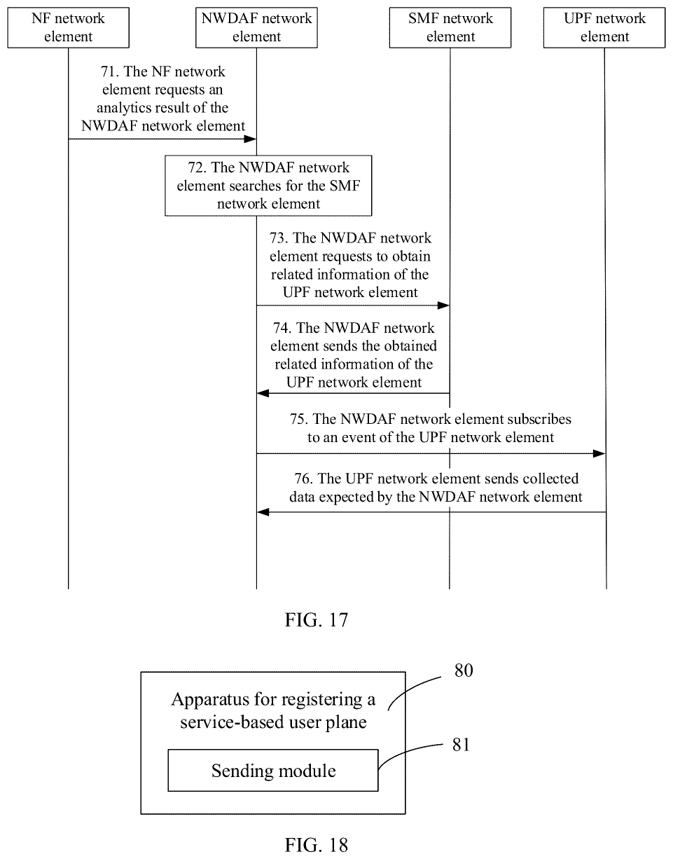

As shown in FIG. 17, the method for subscribing to user plane service information provided in this embodiment of this application includes the following step 71 to step 76.

Step 71: An NF network element requests an analytics result of an NWDAF through signaling Nnwdaf_AnalyticsSubscription_Subscribe, where the signaling carries parameters:

Analytics ID=UE communication (or may be another Analytics ID of the NWDAF in Embodiment 1), Target of Analytics Reporting=SUPI, and Analytics Filter Information=(Application ID, Area of Interest, etc.).

Step 72: The NWDAF network element may use an SUPI to discover, according to step 4 to step 5 in Embodiment 3-1, an SMF network element that serves UE (which is actually an SMF that serves a PDU session of the UE), to obtain an SMF ID, an SMF IP address, and the like.

Step 73: The NWDAF network element triggers a request to obtain an IP address of a UPF network element, so as to subscribe to and obtain information about the UPF network element.

The NWDAF triggers a request, to expect to obtain related information of the UPF network element from the SMF network element, for example, through Nsmf_UPFInformation_Get, where parameters include an SUPI, a DNN, and S-NSSAI of the UE. The information is used to obtain the IP address of the UPF network element that serves the current UE.

In addition, the NWDAF network element may further indicate whether to enable the UPF network element that has a serving capability to expose information.

Step 74: The SMF network element discovers the UPF network element, and sends an IP address, an FQDN, and the like of the UE to the NWDAF network element.

Step 75: The NWDAF network element subscribes to an event of the UPF network element through Nupf_EventExposure_Subscribe, where parameters include an event ID, a UE IP, an SUPI, a DNN, and S-NSSAI.

Step 76: After collecting the data expected by the NWDAF network element, the UPF network element sends a notification (notification) to the NWDAF.

It should be noted that for related descriptions and beneficial effects of the foregoing step 71 to step 76, refer to the descriptions of the foregoing embodiment. Details are not described herein again.

FIG. 18 is a schematic structural diagram of an apparatus for registering a service-based user plane according to an embodiment of this application. As shown in FIG. 18, an apparatus 80 for registering a service-based user plane may include a sending module 81.

The sending module 81 is configured to send a target request to a second network element, where the target request is a registration request or a registration update request, and the target request is used to request to register a first network element to the second network element; and in a case that the first network element registers with the second network element, another network element can discover the first network element through the second network element.

This embodiment of this application provides the apparatus for registering a service-based user plane. The apparatus for registering a service-based user plane may register the first network element to the second network element through a registration response or a registration update response, so that another network element can discover the first network element through the second network element, thereby resolving a problem of how a UPF network element registers with an NRF network element and can be discovered by an SMF network element.

In an implementation, the target request includes at least one of the following: related information of the first network element and first target indication information, where the first target indication information is used to indicate whether the first network element is a service-based user plane network element; and the related information of the first network element includes at least one of the following: an IP address of UE, an SUPI or a GPSI of the UE, a DNN of the UE, S-NSSAI of the UE, a related service supported by the first network element, a related service that is of the first network element and that is requested for subscription, and fourth indication information, where the fourth indication information is used to instruct the first network element that requests service orientation to provide the related service of the first network element.

In an implementation, the first target indication information includes at least one of the following: first indication information, second indication information, and third indication information, where the first indication information is used to indicate whether the first network element can expose the related service of the first network element to another network element, the second indication information is used to indicate whether the related service of the first network element is allowed to be directly or indirectly subscribed by another network element, and the third indication information is used to indicate whether the first network element has a capability of obtaining a related service of another network element.

In an implementation, the related service of the first network element includes at least one of the following: a QoS flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, and QoS monitoring indication information of the first network element, where the first device is the first network element or UE, and the QoS monitoring indication information is used to indicate whether the first network element can provide QoS monitoring through service-based signaling.

In an implementation, each service in the related service of the first network element corresponds to one event identifier; and the apparatus 80 for registering a service-based user plane provided in this embodiment of this application further includes a receiving module. The receiving module is configured to: after the sending module 81 sends the target request to the second network element, receive a subscription request sent by another network element, where the subscription request is used to request to subscribe to the related service of the first network element, and the subscription request includes at least one event identifier; and the sending module 81 is further configured to send a service corresponding to the at least one event identifier in the related service of the first network element to the another network element through service-based signaling.

In an implementation, the first target indication information includes the third indication information; and the first network element has a capability of obtaining a related service of a session management function SMF network element, and the related service of the SMF network element is a service that the SMF network element can expose, where the related service of the SMF network element includes at least one of the following:
UE IP address/prefix provision, or UE IP address/prefix change notification;
PDU session establishment and/or PDU session release notification;
a UP path change notification service;
a change notification service of an access type;
a change notification service of an RAT type;
a PLMN change notification service;
a QFI configuration service;
PDU session information of a wireless local area network;
user plane status information;
a session management congestion control capability of a PDU session;
a UE session behavior trend;
UE behavior; and
a UE communications trend.

In an implementation, the first target indication information includes the third indication information; and the first network element has a capability of obtaining a related service of an NWDAF network element, and the related service of the NWDAF network element is an analytics function, a data collection function, or a statistical function that the NWDAF network element can expose, where the related service of the NWDAF network element includes at least one of the following:
load level information;
service experience information;
network element load information;
network performance statistics or prediction;
UE mobility statistics or prediction;
UE communication analytics or prediction;
terminal abnormal behavior analytics or prediction;
user data congestion analytics or prediction;
QoS sustainability analytics or prediction;
session management congestion control experience analytics or prediction;
redundant transmission experience analytics or prediction;
wireless local area network performance analytics or prediction;
UE dispersion;
data network performance analytics or prediction; and
a capability of the related service of the NWDAF network element.

In an implementation, the apparatus 80 for registering a service-based user plane provided in this embodiment of this application further includes a receiving module. The receiving module is configured to: after the sending module 81 sends the target request to the second network element, receive a target response sent by the second network element, where the target response is a registration response or a registration update response, and the target response is used to instruct the first network element to complete registration or registration update.

The apparatus for registering a service-based user plane provided in this embodiment of this application can implement the processes implemented by the first network element in the foregoing method embodiment, and achieve a same technical effect. To avoid repetition, details are not described herein again.

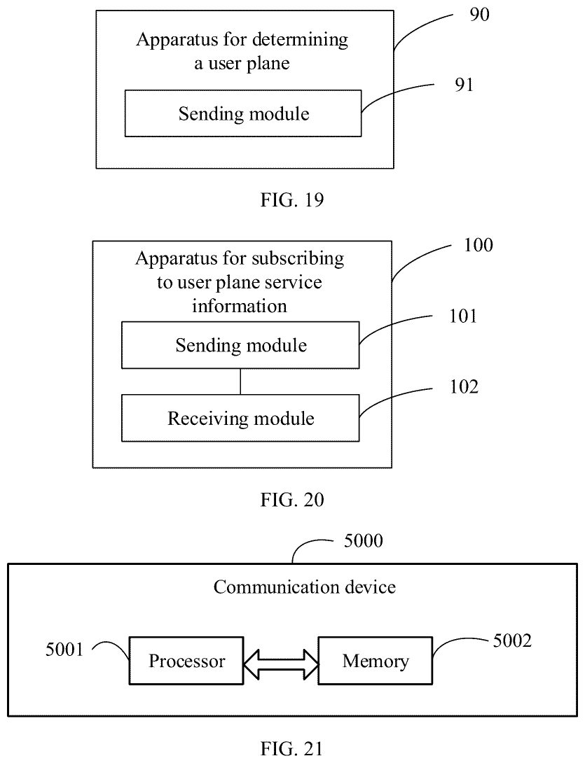

FIG. 19 is a schematic structural diagram of an apparatus for determining a user plane according to an embodiment of this application. As shown in FIG. 19, an apparatus 90 for determining a user plane may include a sending module 91.

The sending module 91 is configured to send a query request to a second network element, where the query request is used to request the second network element to search for a first network element, the query request includes second target indication information, and the second target indication information is used to indicate the first network element that meets a target condition.

This embodiment of this application provides the apparatus for determining a user plane. The apparatus for determining a user plane may request, through the query request, the second network element to search for the first network element. Because the query request includes the second target indication information indicating the first network element that meets the target condition, the second network element can quickly and accurately discover the first network element that meets the target condition (that is, meets a requirement of the third network element).

In an implementation, the first network element that meets the target condition includes at least one of the following: a service-based first network element, a first network element that has a target capability, and a first network element that can use service-based information of another network element.

In an implementation, the first network element that has the target capability is a first network element that can expose a related service; and the related service of the first network element includes at least one of the following: a QoS flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, and QoS monitoring indication information of the first network element, where the first device is the first network element or UE, and the QoS monitoring indication information is used to indicate whether the first network element can provide QoS monitoring through service-based signaling.

In an implementation, the apparatus 90 for determining a user plane provided in this embodiment of this application further includes a receiving module. The receiving module is configured to: after the sending module 91 sends the query request to the second network element, receive a query response sent by the second network element, where the query response includes an IP address, a port number, or an FQDN of a user plane network element that meets the target condition.

The apparatus for determining a user plane provided in this embodiment of this application can implement the processes implemented by the third network element in the foregoing method embodiment, and achieve a same technical effect. To avoid repetition, details are not described herein again.

FIG. 20 is a schematic structural diagram of an apparatus for subscribing to user plane service information according to an embodiment of this application. As shown in FIG. 20, an apparatus 100 for subscribing to user plane service information may include a sending module 101 and a receiving module 102.

The sending module 101 is configured to send a subscription request to a first network element, where the subscription request is used to request to subscribe to a related service of the first network element, and the subscription request includes related information of the first network element. The receiving module 102 is configured to receive notification information sent by the first network element, where the notification information includes the related service of the first network element.

This embodiment of this application provides the apparatus for subscribing to user plane service information. In a case that a third network element discovers the first network element, the apparatus for subscribing to user plane service information may directly or indirectly send the subscription request to the first network element to subscribe to the related service of the first network element, that is, may directly subscribe to the related service of the first network element, or indirectly subscribe to the related service of the first network element through the third network element, so as to obtain, from the first network element, the related service exposed by the first network element.

In an implementation, the related information of the first network element includes at least one of the following: an IP address of UE, an SUPI or a GPSI of the UE, a DNN of the UE, S-NSSAI of the UE, the related service that is of the first network element and that is requested for subscription, a related service supported by the first network element, and fourth indication information, where the fourth indication information is used to instruct the first network element that requests service orientation to provide the related service of the first network element.

In an implementation, the related service of the first network element includes at least one of the following: a QoS flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, and QoS monitoring indication information of the first network element, where the first device is the first network element or UE, and the QoS monitoring indication information is used to indicate whether the first network element can provide QoS monitoring through service-based signaling.

In an implementation, the fourth network element is an AF network element. The sending module 101 is specifically configured to: send the subscription request to a third network element through an NEF network element, where the subscription request is used by the third network element to determine the first network element; and send the subscription request to the first network element through the third network element. The receiving module 102 is specifically configured to receive the notification information sent by the first network element through the third network element and the NEF network element; or directly receive the notification information sent by the first network element.

In an implementation, the fourth network element is an AF network element. The sending module 101 is specifically configured to: send the subscription request to an NEF network element, and send a determining request to a third network element according to the subscription request through the NEF network element, where the determining request is used by the third network element to determine the first network element, and the determining request includes the related information of the first network element; and send an IP address, a port number, or an FQDN of the first network element to the NEF network element through the third network element, and send the subscription request to the first network element through the NEF network element. The receiving module 102 is specifically configured to receive the notification information sent by the first network element through the NEF network element. In an implementation, the fourth network element is an NWDAF network element.

The sending module 101 is specifically configured to: send the subscription request to a third network element, where the subscription request is used by the third network element to determine the first network element; and send the subscription request to the first network element through the third network element. The receiving module 102 is specifically configured to receive the notification information sent by the first network element through the third network element; or directly receive the notification information sent by the first network element.

In an implementation, the subscription request further includes at least one of the following: fifth indication information and sixth indication information, where the fifth indication information is used to instruct to request, through the third network element, the first network element to expose the related service of the first network element, and the sixth indication information is used to indicate whether to allow a user plane network element that has a service-based capability to expose a related service.

In an implementation, the fourth network element is an NWDAF network element. The sending module 101 is specifically configured to: send the subscription request to a third network element, where the subscription request is used by the third network element to determine the first network element; and receive an IP address, a port number, or an FQDN of the first network element sent by the third network element, and send the subscription request to the first network element. The receiving module 102 is specifically configured to directly receive the notification information sent by the first network element.

The apparatus for subscribing to user plane service information provided in this embodiment of this application can implement the processes implemented by the fourth network element in the foregoing method embodiment, and achieve a same technical effect. To avoid repetition, details are not described herein again.

In some implementations, as shown in FIG. 21, an embodiment of this application further provides a communication device 5000, including a processor 5001 and a memory 5002. The memory 5002 stores a program or an instruction that can be run on the processor 5001. For example, when the communication device 5000 is a network element, the program or the instruction is executed by the processor 5001 to implement the steps of the method embodiment on the first network element side, and can achieve a same technical effect, or implement the steps of the method embodiment on the third network element side, and can achieve a same technical effect, or implement the steps of the method embodiment on the fourth network element side, and can achieve a same technical effect. To avoid repetition, details are not described herein again.

An embodiment of this application further provides a network element, including a processor and a communication interface. The communication interface is configured to send a target request to a second network element, where the target request is a registration request or a registration update request, and the target request is used to request to register a first network element to the second network element; and in a case that the first network element registers with the second network element, another network element can discover the first network element through the second network element. This network element embodiment corresponds to the foregoing method embodiment on the first network element side. Each implementation process and implementation of the foregoing method embodiment may be applicable to this network element embodiment, and a same technical effect can be achieved.

An embodiment of this application further provides a network element, including a processor and a communication interface. The communication interface is configured to send a query request to a second network element, where the query request is used to request the second network element to search for a first network element, the query request includes second target indication information, and the second target indication information is used to indicate the first network element that meets a target condition. This network element embodiment corresponds to the foregoing method embodiment on the third network element side. Each implementation process and implementation of the foregoing method embodiment may be applicable to this network element embodiment, and a same technical effect can be achieved.

An embodiment of this application further provides a network element, including a processor and a communication interface. The communication interface is configured to: send a subscription request to a first network element, where the subscription request is used to request to subscribe to a related service of the first network element, and the subscription request includes related information of the first network element; and receive notification information sent by the first network element, where the notification information includes the related service of the first network element. This network element embodiment corresponds to the foregoing method embodiment on the fourth network element side. Each implementation process and implementation of the foregoing method embodiment may be applicable to this network element embodiment, and a same technical effect can be achieved.

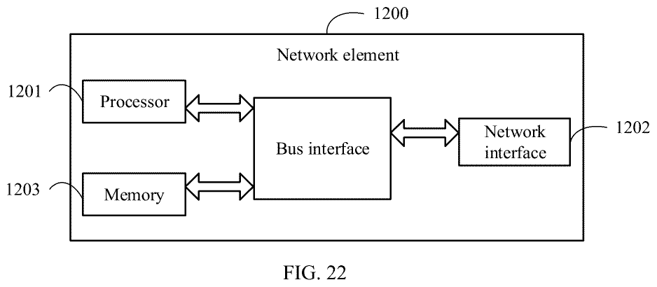

Specifically, FIG. 22 is a schematic structural diagram of hardware of a network element according to an embodiment of this application. The network element is a first network element, or the network element is a third network element, or the network element is a fourth network element.

As shown in FIG. 22, the network element 1200 includes a processor 1201, a network interface 1202, and a memory 1203. The network interface 1202 is, for example, a common public radio interface.

Specifically, the network element 1200 in this embodiment of this application further includes an instruction or a program that is stored in the memory 1203 and that can be run on the processor 1201. The processor 1201 invokes the instruction or the program in the memory 1203 to perform the method performed by the foregoing modules, and achieves a same technical effect. To avoid repetition, details are not described herein again.

The network element provided in this embodiment of this application can implement the processes implemented by the first network element, the third network element, and the fourth network element in the foregoing method embodiments, and achieve a same technical effect. To avoid repetition, details are not described herein again.

An embodiment of this application further provides a readable storage medium. The readable storage medium stores a program or an instruction, and the program or the instruction is executed by a processor to implement the processes of the foregoing method embodiment, and a same technical effect can be achieved. To avoid repetition, details are not described herein again.

The processor is a processor in the communication device in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the computer program/program product is executed by at least one processor to implement the processes of the foregoing method embodiment, and a same technical effect can be achieved. To avoid repetition, details are not described herein again.

An embodiment of this application further provides a communication system, including a first network element, a third network element, and a fourth network element. The first network element may be configured to perform the steps of the foregoing the method for registering a service-based user plane, the third network element may be configured to perform the steps of the foregoing method for determining a user plane, and the fourth network element may be configured to perform the steps of the foregoing method for subscribing to user plane service information.

It should be noted that, in this specification, the terms “include,” “comprise,” or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A method for registering a service-based user plane, performed by a first network element, comprising:
sending a target request to a second network element, wherein the target request is a registration request or a registration update request, and the target request is used to request to register the first network element to the second network element; and
when the first network element registers with the second network element, another network element is configured to discover the first network element through the second network element.

2. The method according to claim 1, wherein the target request comprises at least one of the following: related information of the first network element or first target indication information, wherein
the first target indication information is used to indicate whether the first network element is a service-based user plane network element; and
the related information of the first network element comprises at least one of the following: an Internet Protocol (IP) address of User Equipment (UE), a SUbscription Permanent Identifier (SUPI) or a Generic Public Subscription Identifier (GPSI) of the UE, a Data Network Name (DNN) of the UE, Single Network Slice Selection Assistance Information (S-NSSAI) of the UE, a related service supported by the first network element, a related service that is of the first network element and that is requested for subscription, or fourth indication information, wherein the fourth indication information is used to instruct the first network element that requests service orientation to provide the related service of the first network element.

3. The method according to claim 2, wherein the first target indication information comprises at least one of the following: first indication information, second indication information, or third indication information, wherein
the first indication information is used to indicate whether the first network element is configured to expose the related service of the first network element to another network element, the second indication information is used to indicate whether the related service of the first network element is allowed to be directly or indirectly subscribed by another network element, and the third indication information is used to indicate whether the first network element has a capability of obtaining a related service of another network element.

4. The method according to claim 3, wherein the related service of the first network element comprises at least one of the following: a Quality of Service (QOS) flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, or QoS monitoring indication information of the first network element, wherein
the first device is the first network element or the UE, and the QoS monitoring indication information is used to indicate whether the first network element is configured to provide QoS monitoring through service-based signaling.

5. The method according to claim 4, wherein each service in the related service of the first network element corresponds to one event identifier; and
after the sending a target request to a second network element, the method further comprises:
receiving a subscription request sent by another network element, wherein the subscription request is used to request to subscribe to the related service of the first network element, and the subscription request comprises at least one event identifier; and
sending a service corresponding to the at least one event identifier in the related service of the first network element to the another network element through service-based signaling.

6. The method according to claim 3, wherein the first target indication information comprises the third indication information; and
the first network element has a capability of obtaining a related service of a Session Management Function (SMF) network element, and the related service of the SMF network element is a service that the SMF network element is configured to expose, wherein
the related service of the SMF network element comprises at least one of the following:
UE IP address or prefix provision, or UE IP address or prefix change notification;
Protocol Data Unit (PDU) session establishment or PDU session release notification;
a User Plane (UP) path change notification service;
a change notification service of an access type;
a change notification service of a Radio Access Technology (RAT) type;
a Public Land Mobile Network (PLMN) change notification service;
a QoS Flow Identifier (QFI) configuration service;
PDU session information of a wireless local area network;
user plane status information;
a session management congestion control capability of a PDU session;
a UE session behavior trend;
UE behavior; or
a UE communications trend.

7. The method according to claim 3, wherein the first target indication information comprises the third indication information; and
the first network element is configured to obtain a related service of a NetWork Data Analytics Function (NWDAF) network element, and the related service of the NWDAF network element is an analytics function, a data collection function, or a statistical function that the NWDAF network element is configured to expose, wherein
the related service of the NWDAF network element comprises at least one of the following:
load level information;
service experience information;
network element load information;
network performance statistics or prediction;
UE mobility statistics or prediction;
UE communication analytics or prediction;
terminal abnormal behavior analytics or prediction;
user data congestion analytics or prediction;
QoS sustainability analytics or prediction;
session management congestion control experience analytics or prediction;
redundant transmission experience analytics or prediction;
wireless local area network performance analytics or prediction;
UE dispersion;
data network performance analytics or prediction; or
a capability of the related service of the NWDAF network element.

8. The method according to claim 1, wherein after the sending a target request to a second network element, the method further comprises:
receiving a target response sent by the second network element, wherein the target response is a registration response or a registration update response, and the target response is used to instruct the first network element to complete registration or registration update.

9. A method for determining a user plane, performed by a third network element, comprising:
sending a query request to a second network element, wherein the query request is used to request the second network element to search for a first network element, the query request comprises second target indication information, and the second target indication information is used to indicate the first network element that meets a target condition.

10. The method according to claim 9, wherein the first network element that meets the target condition comprises at least one of the following: a service-based first network element, a first network element that has a target capability, or a first network element that is configured to use service-based information of another network element.

11. The method according to claim 10, wherein the first network element that has the target capability is a first network element that is configured to expose a related service; and
the related service of the first network element comprises at least one of the following: a Quality of Service (QOS) flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, or QoS monitoring indication information of the first network element, wherein
the first device is the first network element or User Equipment (UE), and the QoS monitoring indication information is used to indicate whether the first network element is configured to provide QoS monitoring through service-based signaling.

12. The method according to claim 9, wherein after the sending a query request to a second network element, the method further comprises:
receiving a query response sent by the second network element, wherein the query response comprises an Internet Protocol (IP) address, a port number, or a Fully Qualified Domain Name (FQDN) of a user plane network element that meets the target condition.

13. A method for subscribing to user plane service information, performed by a fourth network element, comprising:
sending a subscription request to a first network element, wherein the subscription request is used to request to subscribe to a related service of the first network element, and the subscription request comprises related information of the first network element; and
receiving notification information sent by the first network element, wherein the notification information comprises the related service of the first network element.

14. The method according to claim 13, wherein the related information of the first network element comprises at least one of the following: an Internet Protocol (IP) address of User Equipment (UE), a SUbscription Permanent Identifier (SUPI) or a Generic Public Subscription Identifier (GPSI) of the UE, a Data Network Name (DNN) of the UE, Single Network Slice Selection Assistance Information (S-NSSAI) of the UE, the related service that is of the first network element and that is requested for subscription, a related service supported by the first network element, or fourth indication information, wherein the fourth indication information is used to instruct the first network element that requests service orientation to provide the related service of the first network element.

15. The method according to claim 13, wherein the related service of the first network element comprises at least one of the following: a Quality of Service (QOS) flow bit rate of a first device, a QoS flow packet delay of the first device, a quantity of packets transmitted by the first device, a quantity of packets retransmitted by the first device, resource information of the first network element, load information of the first network element, a traffic volume of the first network element, a throughput of the first network element, a QoS monitoring report of the first network element, or QoS monitoring indication information of the first network element, wherein
the first device is the first network element or User Equipment (UE), and the QoS monitoring indication information is used to indicate whether the first network element is configured to provide QoS monitoring through service-based signaling.

16. The method according to claim 13, wherein the fourth network element is an Application Function (AF) network element;
the sending a subscription request to a first network element comprises:
sending the subscription request to a third network element through a Network Exposure Function (NEF) network element, wherein the subscription request is used by the third network element to determine the first network element; and
sending the subscription request to the first network element through the third network element; and
the receiving notification information sent by the first network element comprises:
receiving the notification information sent by the first network element through the third network element and the NEF network element; or
directly receiving the notification information sent by the first network element.

17. The method according to claim 13, wherein the fourth network element is an Application Function (AF) network element;
the sending a subscription request to a first network element comprises:
sending the subscription request to a Network Exposure Function (NEF) network element, and sending a determining request to a third network element according to the subscription request through the NEF network element, wherein the determining request is used by the third network element to determine the first network element, and the determining request comprises the related information of the first network element; and
sending an Internet Protocol (IP) address, a port number, or a Fully Qualified Domain Name (FQDN) of the first network element to the NEF network element through the third network element, and sending the subscription request to the first network element through the NEF network element; and
the receiving notification information sent by the first network element comprises:
receiving the notification information sent by the first network element through the NEF network element.

18. The method according to claim 13, wherein the fourth network element is a NetWork Data Analytics Function (NWDAF) network element;
the sending a subscription request to a first network element comprises:
sending the subscription request to a third network element, wherein the subscription request is used by the third network element to determine the first network element; and
sending the subscription request to the first network element through the third network element; and
the receiving notification information sent by the first network element comprises:
receiving the notification information sent by the first network element through the third network element; or
directly receiving the notification information sent by the first network element.

19. The method according to claim 18, wherein the subscription request further comprises at least one of the following: fifth indication information or sixth indication information, wherein the fifth indication information is used to instruct to request, through the third network element, the first network element to expose the related service of the first network element, and the sixth indication information is used to indicate whether to allow a user plane network element that has a service-based capability to expose a related service.

20. The method according to claim 13, wherein the fourth network element is a NetWork Data Analytics Function (NWDAF) network element;
the sending a subscription request to a first network element comprises:
sending the subscription request to a third network element, wherein the subscription request is used by the third network element to determine the first network element; and
receiving an Internet Protocol (IP) address, a port number, or a Fully Qualified Domain Name (FQDN) of the first network element sent by the third network element, and sending the subscription request to the first network element; and
the receiving notification information sent by the first network element comprises:
directly receiving the notification information sent by the first network element.
